(19) United States
(12) Patent Application Publication
(10) Pub. No.: US 2026/0321970 A1
(43) Pub. Date: Oct. 15, 2026

(54) TRANSMISSION LINE, ANTENNA ELEMENT, PHASE SHIFTER, FEED NETWORK, ANTENNA, AND COMMUNICATION DEVICE

(71) Applicant: Huawei Technologies Co., Ltd., Shenzhen (CN)

(72) Inventors: Chengdai Xue, Dongguan (CN); Meidi Yang, Dongguan (CN); Di Xue, Dongguan (CN); Fenli Zheng, Dongguan (CN); Tuanhui Xue, Dongguan (CN)

(21) Appl. No.: 19/699,093

(22) Filed: Jun. 5, 2026

Related U.S. Application Data
(63) Continuation of application No. PCT/CN2024/137018, filed on Dec. 5, 2024.

(30) Foreign Application Priority Data
Dec. 8, 2023 (CN) 202311689902.6

(51) Int. Cl. H01Q 1/50; H01P 1/18; H01P 3/08; H01Q 1/36; H01Q 3/30

(52) U.S. Cl. CPC H01Q 1/50; H01P 1/182; H01P 3/08; H01Q 1/36; H01Q 3/30

(57) ABSTRACT

This application provides a transmission line, an antenna element, a phase shifter, a feed network, an antenna, and a communication device. The transmission line includes: a first inner conductor, including a first main surface, where the first main surface is perpendicular to a thickness direction of the first inner conductor; and a ground, including a first slot hole extending through a thickness of the ground, where an inner wall of the first slot hole is coupled to the first main surface to form a capacitance. According to the foregoing technical solution, tolerance sensitivity of an impedance of the transmission line can be reduced, and tolerance robustness of the transmission line can be improved, thereby helping ensure stability of the impedance of the transmission line.

### CROSS-REFERENCE TO RELATED APPLICATIONS

This application is a continuation of International Application No. PCT/CN2024/137018, filed on Dec. 5, 2024, which claims priority to Chinese Patent Application No. 202311689902.6, filed on Dec. 8, 2023. The disclosures of the aforementioned applications are hereby incorporated by reference in their entireties.

### TECHNICAL FIELD

This application relates to the communication field, and more specifically, to a transmission line, an antenna element, a phase shifter, a feed network, an antenna, and a communication device.

### BACKGROUND

A transmission line (transmission line) is a wire or conductor system with specific parameters and a characteristic impedance. A basic structure of the transmission line includes an inner conductor (inner conductor) and a ground (ground), where the inner conductor and the ground form a capacitance. In a wireless communication system, the transmission line connects main parts of the entire system. The transmission line is required not only to be capable of transmitting signals, but also to ensure stability of signal transmission. Generally, a stable impedance of the transmission line can ensure stability and reliability of signal transmission.

However, an impedance of an existing transmission line is sensitive to changes in a relative position between the inner conductor and the ground, and is prone to drastic changes, thereby affecting quality of signal transmission. Therefore, how to ensure stability of the impedance of the transmission line becomes an urgent problem to be resolved.

### SUMMARY

This application provides a transmission line, an antenna element, a phase shifter, a feed network, an antenna, and a communication device, to ensure stability of an impedance of the transmission line.

According to a first aspect, a transmission line is provided. The transmission line includes: a first inner conductor, including a first main surface, where the first main surface is perpendicular to a thickness direction of the first inner conductor; and a ground, including a first slot hole extending through a thickness of the ground, where an inner wall of the first slot hole is coupled to the first main surface to form a capacitance.

In embodiments of this application, the inner wall of the first slot hole is coupled to the first main surface of the first inner conductor to form the capacitance. When a relative position between the first inner conductor and the ground changes, a coupling capacitance between the first inner conductor and the ground changes slightly or remains substantially unchanged. This improves tolerance robustness of the impedance of the transmission line, and therefore helps ensure stability of the impedance of the transmission line.

With reference to the first aspect, in some implementations of the first aspect, at least a part of a projection of the first inner conductor in a first direction overlaps with a projection of the first slot hole in the first direction, and the thickness direction of at least a part of the first inner conductor intersects with a thickness direction of the ground, where the first direction is the thickness direction of the ground.

When a relative position between the first inner conductor and the ground in the vertical dimension and/or the horizontal dimension changes, a capacitance composition condition can still be met, and impact on the capacitance between the first inner conductor and the ground is small. In this way, stability of the capacitance formed between the first inner conductor and the ground can be maintained, the stability of the impedance of the transmission line can be ensured, and stability and reliability of a signal transmitted by the transmission line can be further ensured. Because the impedance of the transmission line is less sensitive to changes in the relative position between the first inner conductor and the inner wall of the first slot hole, a high-precision processing technique or a high-cost fastening solution is not required in a processing and mounting process, and fastening costs can be reduced.

With reference to the first aspect, in some implementations of the first aspect, the thickness direction of at least the part of the first inner conductor is perpendicular to the thickness direction of the ground.

This helps to form the capacitance by coupling the first inner conductor and the ground. In addition, when sizes of the first inner conductor and the ground are fixed, this arrangement can improve a tolerance range of the impedance of the transmission line, thereby maintaining the stability of the impedance of the transmission line.

With reference to the first aspect, in some implementations of the first aspect, the first main surface is parallel to the thickness direction of the ground.

When there is a tolerance between the first inner conductor and the ground in the vertical dimension (namely, the thickness direction of the ground), stability of the capacitance between the first inner conductor and the ground can still be maintained.

With reference to the first aspect, in some implementations of the first aspect, the first main surface includes a first surface and a second surface that are disposed opposite to each other; and the first slot hole includes a first wall facing the first surface and a second wall facing the second surface, where the first wall is parallel to the first surface, and the second wall is parallel to the second surface.

In this way, contact between the first inner conductor and the ground can be avoided, and reliability of the capacitance can be improved.

With reference to the first aspect, in some implementations of the first aspect, the first inner conductor is disposed in the first slot hole.

In this way, a coupling field between the first inner conductor and the inner wall of the first slot hole and a capability of binding an electric field can be enhanced, and a transmission loss of the transmission line can be reduced.

With reference to the first aspect, in some implementations of the first aspect, a projection of the first main surface in a second direction is divided into two parts arranged in the thickness direction of the ground by a projection of the ground in the second direction, and the second direction is a width direction of the ground.

In this way, when there is a tolerance in a position or a size of the first inner conductor or the ground in the vertical dimension (namely, the thickness direction of the ground), a coupling area between the first inner conductor and the ground may remain unchanged, and the stability of the capacitance between the first inner conductor and the ground can be ensured.

With reference to the first aspect, in some implementations of the first aspect, the first slot hole includes a first slot section and a second slot section that are spaced apart in a third direction, and the third direction is a length direction of the ground; and the first inner conductor includes a first part, a second part, and a third part that connects the first part and the second part, where the first part is disposed in the first slot section, the second part is disposed in the second slot section, and the third part is located outside the first slot hole and is not in contact with a part of the ground separating the first slot section from the second slot section.

The first slot hole may include a plurality of slot sections spaced apart, so that strength of the ground can be enhanced without affecting performance of the transmission line.

With reference to the first aspect, in some implementations of the first aspect, a thickness direction of the third part is the same as a thickness direction of the first part and/or a thickness direction of the second part.

All parts of the first inner conductor have a same thickness direction. In this way, the first inner conductor may be in a plate shape, a processing technique is simple, and mounting is convenient.

With reference to the first aspect, in some implementations of the first aspect, a thickness direction of the third part is perpendicular to a thickness direction of the first part and/or a thickness direction of the second part; and/or the thickness direction of the third part is parallel to the thickness direction of the ground.

A coupling area between the third part of the first inner conductor and the ground is increased, so that continuity of the impedance of the transmission line can be improved.

With reference to the first aspect, in some implementations of the first aspect, the transmission line further includes a second inner conductor, the second inner conductor includes a second main surface, and the second main surface is perpendicular to a thickness direction of the second inner conductor; and the ground further includes a second slot hole extending through the thickness of the ground, the second slot hole and the first slot hole are spaced apart in the width direction of the ground, and an inner wall of the second slot hole is coupled to the second main surface to form a capacitance.

Slot holes are provided side by side on the ground, to facilitate integration of multi-polarized feed lines and occupy small space in a direction perpendicular to the thickness of the ground.

With reference to the first aspect, in some implementations of the first aspect, a length direction of the second slot hole is parallel to a length direction of the first slot hole.

The first slot hole and the second slot hole are provided side by side, to facilitate integration and mounting of a plurality of feed lines.

With reference to the first aspect, in some implementations of the first aspect, coupling between the first slot hole and the first inner conductor is configured to transmit a first signal, and coupling between the second slot hole and the second inner conductor is configured to transmit a second signal.

In this way, the transmission line may occupy smaller space to transmit a plurality of feed line signals.

According to a second aspect, an antenna element is provided, including: a radiator, configured to transmit and receive a radio frequency signal; and a balun, electrically connected to the radiator, where the balun includes the transmission line according to any one of the first aspect and the implementations of the first aspect, to feed the radiator.

The balun of the antenna element uses a transmission line structure in the first aspect, to help ensure stability of an impedance of the balun.

With reference to the second aspect, in some implementations of the second aspect, the antenna element further includes a feed line part, electrically connected to the balun, where the feed line part includes the transmission line according to any one of the first aspect and the implementations of the first aspect, to feed the balun.

Both the balun and the feed line part of the antenna element use the transmission line structure in the first aspect. Therefore, the balun and the feed line part are insensitive to changes in the positions of the inner conductor and the ground, and a high robustness design can be implemented.

With reference to the second aspect, in some implementations of the second aspect, a ground in the balun is connected to a ground in the feed line part; and/or a first inner conductor in the balun is connected to a first inner conductor in the feed line part.

With reference to the second aspect, in some implementations of the second aspect, the radiator, the ground in the balun, and the ground in the feed line part are integrally formed.

The radiator, the ground in the balun, and the ground in the feed line part are appropriately arranged, to achieve integrated formation through a single processing technique, for example, by using single-sided sheet metal bending. This process is simple, and costs are low.

With reference to the second aspect, in some implementations of the second aspect, the first inner conductor in the balun and the first inner conductor in the feed line part are integrally formed.

In this way, balun feeding and the feed line feeding can be achieved by mounting only one part, so that mounting is simple, and costs are low.

With reference to the second aspect, in some implementations of the second aspect, the first inner conductor in the balun and the first inner conductor in the feed line part are part of a +45° feed line or part of a −45° feed line.

In this way, the balun and the feed line part may be used for ±45° dual-polarized feeding.

According to a third aspect, a phase shifter is provided, including the transmission line according to any one of the first aspect and the implementations of the first aspect.

With reference to the third aspect, in some implementations of the third aspect, the phase shifter further includes: an input stub, where the input stub is connected to the first inner conductor, and the first inner conductor includes at least two output ports; and a phase-shifting medium, disposed between the inner wall of the first slot hole and the first main surface, where the phase-shifting medium is configured to adjust a phase difference between the at least two output ports.

The phase shifter uses a transmission line structure according to the first aspect, to help ensure stability of an impedance of the phase shifter.

With reference to the third aspect, in some implementations of the third aspect, the first main surface includes a first surface and a second surface that are disposed opposite to each other; the first slot hole includes a first wall facing the first surface and a second wall facing the second surface; and the phase-shifting medium is disposed between the first surface and the first wall and/or between the second surface and the second wall.

The phase-shifting medium can be disposed to implement a phase-shifting function. In addition, when the phase-shifting medium is loaded on two wide surfaces of the first inner conductor, a phase shift amount can be increased.

According to a fourth aspect, a feed network is provided, including the transmission line according to any one of the first aspect and the implementations of the first aspect, or including the phase shifter according to any one of the third aspect and the implementations of the third aspect.

According to a fifth aspect, an antenna is provided, including the transmission line according to any one of the first aspect and the implementations of the first aspect, or including the antenna element according to any one of the second aspect and the implementations of the second aspect, or including the phase shifter according to any one of the third aspect and the implementations of the third aspect, or including the feed network according to the fourth aspect.

According to a sixth aspect, a communication device is provided, including the antenna according to the fifth aspect.

With reference to the sixth aspect, in some implementations of the sixth aspect, the communication device further includes a radio frequency module, and the radio frequency module is configured to send a radio frequency signal to the antenna.

With reference to the sixth aspect, in some implementations of the sixth aspect, the communication device further includes an energy device, and the energy device is configured to provide electric energy for the radio frequency module and the antenna.

Optionally, the communication device is a base station.

According to a seventh aspect, a communication system is provided, including a terminal device and the communication device according to any one of the sixth aspect and the implementations of the sixth aspect.

For beneficial effect of apparatuses according to the second aspect to the seventh aspect, refer to related descriptions of the first aspect. For brevity, details are not described again.

### BRIEF DESCRIPTION OF THE DRAWINGS

FIG. 1 is a diagram of an architecture of a communication system according to an embodiment of this application;

FIG. 2 is a diagram of a structure of an antenna system according to an embodiment of this application;

FIG. 3 is a block diagram of a structure of an antenna according to an embodiment of this application;

FIG. 4A-FIG. 4B, FIG. 5A-FIG. 5B, and FIG. 6A to FIG. 6B are diagrams of structures of several existing transmission lines;

FIG. 7 is a diagram of a structure of a transmission line according to an embodiment of this application;

FIG. 8A and FIG. 8B are a schematic front view and a schematic top view of the transmission line in FIG. 7;

FIG. 9A to FIG. 9C are diagrams of a structure of a transmission line according to an embodiment of this application;

FIG. 10A and FIG. 10B are diagrams of a structure of another transmission line according to an embodiment of this application;

FIG. 11A to FIG. 11C are diagrams of a structure of another transmission line according to an embodiment of this application;

FIG. 12A to FIG. 12C are diagrams of a structure of another transmission line according to an embodiment of this application;

FIG. 13A to FIG. 13C are diagrams of a structure of another transmission line according to an embodiment of this application;

FIG. 14 is a diagram of a structure of another transmission line according to an embodiment of this application;

FIG. 15A and FIG. 15B are diagrams of effect comparison of impedances of several transmission lines changing with a size tolerance;

FIG. 16 and FIG. 17 are diagrams of a structure of an antenna element according to an embodiment of this application;

FIG. 18 is a diagram of a structure of an antenna element before an antenna element body is formed according to an embodiment of this application;

FIG. 19A to FIG. 21 are diagrams of a structure of a phase shifter according to an embodiment of this application; and

FIG. 22 is a diagram of a structure of an inner conductor according to an embodiment of this application.

### DETAILED DESCRIPTION OF ILLUSTRATIVE EMBODIMENTS

The following describes technical solutions of this application with reference to accompanying drawings.

It should be noted that, in descriptions of embodiments of this application, unless otherwise specified, “/” means “or”. For example, A/B may indicate A or B. “And/or” in this specification merely describes an association relationship between associated objects, and indicates that three relationships may exist. For example, A and/or B may indicate the following three cases: Only A exists, both A and B exist, and only B exists.

The terms “first”, “second”, and the like in embodiments of this application are merely intended for a purpose of description, and shall not be understood as an indication or implication of relative importance or implicit indication of a quantity of indicated technical features. Therefore, a feature limited by “first”, “second”, or the like may explicitly or implicitly include one or more features. In addition, in the descriptions of embodiments of this application, “a plurality of” means two or more, and “at least one” and “one or more” mean one, two, or more. Singular expression forms “one”, “a”, “the”, “the foregoing”, “this”, and “the one” are also intended to include expression forms such as “one or more”, unless otherwise specified in the context clearly.

Reference to “an embodiment”, “some embodiments”, or the like described in this specification indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. Terms “include”, “contain”, “have”, and variants of the terms all mean “include but are not limited to”, unless otherwise specifically emphasized in another manner.

In the descriptions of embodiments of this application, orientations or position relationships indicated by terms “up”, “down”, “inside”, “outside”, “vertical”, “horizontal”, and the like are defined relative to orientations or positions in which components are schematically placed in the accompanying drawings. It should be understood that these directional terms are relative concepts, and are used for relative description and clarification, but not indicate or imply that a specified apparatus or component needs to have a specific orientation or be constructed and operated in a specific orientation. These directional terms may vary based on changed of positions of the components in the accompanying drawings, and therefore cannot be understood as a limitation on this application. In addition, “vertical” in this application is not strictly vertical, but within an allowable error range. “Parallel” is not strictly parallel, but within an allowable error range.

In embodiments of this application, same reference numerals indicate same components or parts. For same components or parts in embodiments of this application, only one component or part may be marked with a reference numeral in the figure as an example. It should be understood that, this is also applicable to reference numerals of other same components or parts. In addition, the components or parts in the accompanying drawings are not drawn based on an actual scale. Dimensions and sizes of the components or parts shown in the figures are merely examples, and should not be understood as a limitation on this application.

In this application, “in a range of . . . ” includes end values at both ends of the range by default except that it is separately indicated that an end value is not included. For example, a range of 1 to 5 includes the two values 1 and 5.

For ease of understanding, the following first explains and describes technical terms in this application.

Coupling (coupling) includes direct coupling and/or indirect coupling, and a “coupling connection” includes a direct coupling connection and/or an indirect coupling connection. Direct coupling may be understood as a form in which components are physically in contact and electrically connected, or may be understood as a form in which different components in a line structure are connected to each other through a physical line that can transmit an electrical signal, such as a printed circuit board (printed circuit board, PCB) copper foil or a conducting wire. Indirect coupling may be understood as that two conductors are electrically connected to each other in a spaced/non-contact manner. For example, there is no conductor medium interference between a component A and a component B, and energy radiated by the component A may be transmitted to the component B through space between the component A and the component B. In an embodiment, indirect coupling may also be referred to as capacitive coupling. For example, signal transmission is implemented by forming an equivalent capacitance through coupling in a gap between two spaced conductive members.

An element/A component (component) includes at least one of a lumped element/component and a distributed element/component.

The lumped element/component (lumped element) indicates a general term for all elements when sizes of the elements are much smaller than a wavelength corresponding to an operating frequency of a circuit. For a signal, a characteristic of the elements is always constant at any time, regardless of a frequency.

The distributed element/component (distributed element) is different from a lumped element. When a size of an element is similar to or larger than a wavelength corresponding to an operating frequency of a circuit, a characteristic of each point of the element vary with a signal when the signal passes through the element. In this case, the element cannot be considered as a single entity with a fixed characteristic, and should be referred to as a distributed element.

A capacitor (capacitor) includes a lumped capacitor and/or a distributed capacitor. The lumped capacitor is a capacitive component, for example, a capacitive element. The distributed capacitor (or a distributed-type capacitor) is an equivalent capacitor formed by separating two conductive members by a specific gap.

An inductor (inductor) includes a lumped inductor and/or a distributed inductor. The lumped inductor is an inductive component, for example, an inductive element. The distributed inductor (or distributed-type inductor) is an equivalent inductor formed by using a conductive member with a specific length.

A radiation element (radiation element) is also referred to as a driven element, an antenna element (antenna element), or the like, and is a component in an antenna configured to receive/transmit electromagnetic wave radiation. The radiation element is a basic element of an antenna array. The radiation element includes a radiator and a balun.

The radiator (radiator) may convert guided wave energy from a transmitter into a radio wave, or convert a radio wave into guided wave energy, to implement radiation and reception of the radio wave. Modulated high-frequency current energy (or guided wave energy) generated by the transmitter is transmitted to a transmit radiator through a feed line. The radiator converts the modulated high-frequency current energy into specific polarized electromagnetic wave energy, and radiates the electromagnetic wave energy in a needed direction. A receive radiator converts specific polarized electromagnetic wave energy from a specific direction of space into modulated high-frequency current energy, and transmits the modulated high-frequency current energy to an input end of a receiver through a feed line.

A balun (balanced to unbalanced, balun) is also referred to as a balanced-to-unbalanced converter or transformer, and is a device or structure used to implement feeding conversion from an unbalanced structure (for example, a coaxial cable or a microstrip line) to a balanced structure (for example, a dipole), or is a broadband radio frequency transmission line transformer that implements a connection between a balanced transmission line circuit and an unbalanced transmission line circuit by converting a matched input into a differential output. A function of the balun is to enable a system to have different impedances (impedances) or be compatible with differential/single-ended signaling, and may be used to maintain impedance matching and improve signal transmission quality. There are various types of baluns, some of the baluns may be used for impedance conversion, and some of the baluns may be used to connect transmission lines with different impedances. The balun is made of a conductive material, for example, a metal material. There are various commonly used balun structures, for example, a microstrip balun, a coaxial balun, and a sleeve balun. This application provides a new balun structure.

A reflector (reflector) may also be referred to as a ground, a ground plane, an antenna panel, a metal reflective surface, or the like. The reflector is generally a metal plate, and has electrical impact on an antenna. For example, the reflector may be configured to: improve receiving sensitivity for an antenna signal, and reflect and aggregate the antenna signal to a receiving point, thereby enhancing a receiving capability and a transmitting capability of the antenna. In addition, the reflector can block and shield interference of an electromagnetic wave from a back side of the reflector (a direction opposite to a radiation direction of the antenna) to the antenna, thereby enhancing directivity of the antenna.

A feed network (feed network) is an important component in an antenna, connects an antenna port and a radiation element to form a signal transmission path, and can implement functions such as impedance matching and amplitude and phase allocation. A main function of the feed network is to feed a signal from a transmitter to the radiation element based on a specific amplitude and phase, or to send a radio signal received from the radiation element to a receiver based on a specific amplitude and phase. The feed network generally includes a controlled impedance transmission line. In some embodiments, the feed network may further include a phase shifter. In some embodiments, the feed network may further include components such as a combiner and a filter. A feed impedance of the antenna is a combination of a resistance, a capacitance, and an inductance.

A phase shifter (phase shifter) is a device configured to change a feed phase and amplitude of each radiation element in an antenna array, and is configured to implement a phase-shifting function. The phase shifter can change a phase difference of radiation elements, to enable a vertical plane beam of an antenna to form a specific downtilt angle, thereby flexibly changing a coverage area of the beam. The phase shifter is a part of a feed network. Generally, the feed network may include a power divider and a phase shifter connected to each branch of the power divider. In some cases, if phases of a plurality of output ports need to be adjusted at the same time, the phase shifter may include at least one power division section. The power division section is configured to divide one input signal into a plurality of output signals that are equal or unequal, through, for example, two-way power division, four-way power division, or six-way power division. The phase shifter includes a phase-shifting medium, and the phase-shifting medium is disposed in a cavity of the phase shifter and can move along a preset track, to implement the phase-shifting function. The cavity of the phase shifter is made of a conductor material, for example, a metal material (such as aluminum or copper). The phase-shifting medium is usually made of a material with a large dielectric constant, for example, ceramic, aluminum oxide, or an engineering plastic material.

A transmission line (transmission line) is a linear structure, for example, a wire or a wire system, that has specific parameters and a characteristic impedance, and is configured to transmit electromagnetic energy. Specifically, the transmission line is a group of conductor structures that provide signal transmission and return paths, or is a pair of wires formed by any two wires of a specific length, where one wire is referred to as a signal path, and the other wire is referred to as a return path. Generally, a pair of wires included in the transmission line may be respectively referred to as an inner conductor (inner conductor) and a ground (ground). The inner conductor is used as a signal path for signal transmission, and the ground is used as a return path for signal return. The inner conductor may also be referred to as an internal conductor, and is made of a conductor material, for example, a metal material (such as aluminum or copper). The ground may also be referred to as an outer conductor, and is made of a conductor material, for example, a metal material (such as aluminum or copper). The inner conductor is electrically isolated from the ground. Common transmission line structures include a twisted pair, a coaxial line, a coplanar line, a microstrip line, a stripline, and the like. This application provides a new transmission line structure.

A microstrip line (microstrip line) is a signal transmission line including a signal line and an adjacent plane layer (a power plane layer or a ground layer), where the signal line and the plane layer are isolated by a dielectric layer.

A stripline (stripline) is a transmission line including an upper plane layer and a lower plane layer that are adjacent (a power plane layer or a ground layer) and a signal line disposed between the two plane layers, where the signal line and the plane layer are isolated by a dielectric layer.

A coplanar line (coplanar line) is a transmission line in which a signal path and a signal loop of a signal are located on a same signal layer.

An antenna array (antenna array) is an array structure including at least one radiation element arranged according to a specific geometric rule, where the at least one radiation element operates through a shared feed network.

End/Point: The “end/point” in a first end/second end/feed end/grounding end/feed point/grounding point/connection point of an antenna radiator cannot be narrowly understood as an end or end part that is physically disconnected from another radiator, and may also be considered as a point or a segment on a continuous radiator. In an embodiment, the “end/point” may include a connection/coupling area on the antenna radiator coupled to another conductive structure. For example, the feed end/feed point may be a coupling area (for example, an area opposite to a part of a feed circuit) on the antenna radiator coupled to a feed structure or the feed circuit. For another example, the grounding end/grounding point may be a connection/coupling area on the antenna radiator coupled to a grounding structure or a grounding circuit.

A resonance/resonance frequency is also referred to as a resonant frequency, and may be a frequency at which an imaginary part of an input impedance of an antenna is zero. The resonance frequency may have a frequency range, namely, a frequency range in which a resonance occurs. A frequency corresponding to the strongest resonance point is a frequency of a center frequency point.

A resonance frequency band/communication frequency band/operating frequency band is a specific frequency range (a frequency bandwidth) within which, regardless of a type of antenna, the antenna always operates. In this application, A frequency range that meets an indicator requirement may be considered as an operating frequency band of the antenna.

A wavelength (wavelength) or an operating wavelength may be a wavelength corresponding to a center frequency of a resonance frequency or a wavelength corresponding to a center frequency of an operating frequency band supported by an antenna. The “operating wavelength” is not limited to the center frequency, and may alternatively be a wavelength corresponding to a non-center frequency of the resonance frequency or the operating frequency band.

A floor (ground) (ground, GND) may be generally referred to as at least a part of any grounding layer, grounding plate, grounding metal layer, or the like in a communication device, or at least a part of any combination of any grounding layer, grounding plate, grounding component, or the like. The “floor” may be used to ground a component in the communication device. Grounding indicates that a component is coupled to the floor or the ground in any manner.

A tolerance (tolerance) indicates a range of variation in size or performance that is allowed to exist during manufacturing and processing. It may be understood as an allowable deviation between a design requirement and actual production. In a product design, size or performance variation caused by factors such as material characteristics, processing techniques, and assembly errors cannot be completely avoided. The tolerance is introduced to consider these inevitable changes and ensure that a product still meets functional and performance requirements within an allowed range.

FIG. 1 is a diagram of an architecture of a communication system to which an embodiment of this application is applicable. As shown in FIG. 1, the communication system 100 may include a base station 101 and a terminal 102, and wireless communication may be implemented between the base station 101 and the terminal 102.

The terminal 102 in embodiments of this application may be user equipment, an access terminal, a subscriber unit, a subscriber station, a mobile station, a mobile console, a remote station, a remote terminal, a mobile device, a user terminal, a terminal device, a wireless communication device, a user agent, or a user apparatus. As an example rather than a limitation, the terminal 102 may be a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a compute device, another processing device connected to a wireless modem, a vehicle-mounted device, a wearable device, a terminal device in a 5G network, a terminal device in a 6G network, a terminal device in a future evolved public land mobile network (public land mobile network, PLMN), or the like. This is not limited in embodiments of this application.

In embodiments of this application, the base station 101 may also be referred to as an access network device or an access node. The base station 101 has a wireless transceiver function, and is configured to communicate with the terminal. The base station 101 may be located in a base station subsystem (base station subsystem, BSS), a terrestrial radio access network (UMTS terrestrial radio access network, UTRAN), or an evolved universal terrestrial radio access network (evolved universal terrestrial radio access universal, E-UTRAN), and is configured to perform cell coverage of a signal, to implement communication between the terminal and a wireless network. As an example rather than a limitation, the base station 101 may be a base transceiver station (base transceiver station, BTS) in a global system for mobile communications (global system for mobile communications, GSM) or a code division multiple access (code division multiple access, CDMA) system, may be a NodeB (NodeB, NB) in a wideband code division multiple access (wideband code division multiple access, WCDMA) system, may be an evolved NodeB (evolved NodeB, eNB, or eNodeB) in a long term evolution (long term evolution, LTE) system, may be a transmission reception point (transmission reception point, TRP), or may be a next generation node base station (next generation node base station, gNB) in a new radio (new radio, NR) system, a next generation base station in a sixth generation (6th generation, 6G) mobile communication system, an access network device or a module of an access network device in an open access network (open RAN, ORAN) system, a base station in a future mobile communication system, an access node in a wireless fidelity (wireless fidelity, Wi-Fi) system, or the like. Alternatively, the base station 101 may be a module or unit that can implement some functions of the base station. For example, the base station 101 may be a central unit (central unit, CU), a distributed unit (distributed unit, DU), a CU-control plane (control plane, CP), a CU-user plane (user plane, UP), a radio unit (radio unit, RU), or the like. In the ORAN system, the CU may also be referred to as an O-CU, the DU may also be referred to as an open (open, O)-DU, the CU-CP may also be referred to as an O-CU-CP, the CU-UP may also be referred to as an O-CU-UP, and the RU may also be referred to as an O-RU. The base station 101 may be a macro base station, a micro base station, an indoor station, a relay node, or a donor node, or may be a radio controller in a cloud radio access network (cloud radio access network, CRAN) scenario, or may be a relay station, an access point, a vehicle-mounted device, a wearable device, a server, a network device in a future network, or the like. This is not limited in embodiments of this application. For example, an access network device in a vehicle to everything (vehicle to everything, V2X) technology may be a road side unit (road side unit, RSU). A plurality of access network devices in the communication system may be base stations of a same type, or may be base stations of different types. The base station 101 may communicate with the terminal, or may communicate with the terminal via a relay station.

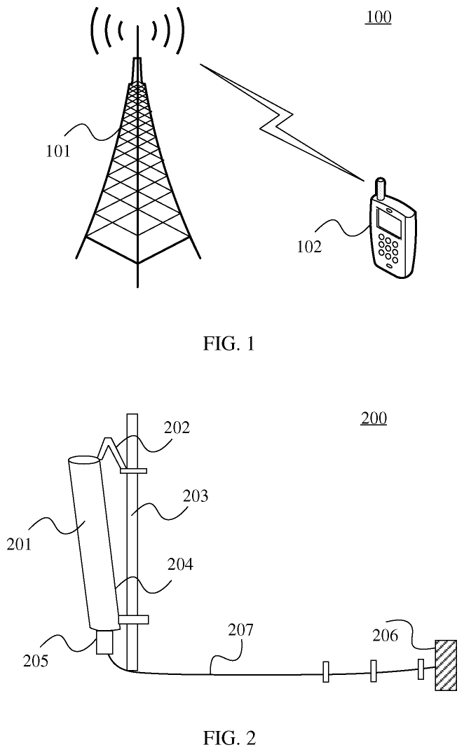

In embodiments of this application, the base station 101 is configured with an antenna system to implement signal transmission in space. For example, FIG. 2 is a diagram of an antenna system configured on the base station 101.

As shown in FIG. 2, the antenna system 200 may include structures such as an antenna 201 and an antenna support 202. In some embodiments, for example, the antenna 201 may be fastened to a pole 203 of the base station 101 through the antenna support 202 (in some scenarios, the pole 203 may also be referred to as a tower).

In some embodiments, the antenna system 200 may include a radome 204, and the radome 204 covers the antenna 201. The radome 204 has a good electromagnetic wave penetration characteristic in terms of electrical performance, and can withstand impact of an external harsh environment in terms of mechanical performance, so that the antenna 201 can be protected from the impact of the external environment. For example, the radome 204 can reduce wind load (wind load, which is pressure generated by the air flow on an engineering structure, and is also referred to as wind dynamic pressure, wind load, or the like) borne by the antenna 201. In embodiments shown in FIG. 2, the radome 204 may be mounted on the pole 203 through the antenna support 202, so that the antenna 201 receives or transmits a signal. For example, the radome 204 may be disposed on a radiation element of the antenna 201 in a manner of electroplating, spraying, or the like.

In embodiments shown in FIG. 2, the antenna system 200 may further include a signal processing apparatus, and the signal processing apparatus may be configured to transmit a signal through the antenna 201. Specifically, the signal processing apparatus sends a signal through the antenna 201, and/or the signal processing apparatus receives a signal through the antenna 201. In some embodiments, the signal processing apparatus may include a radio frequency processing unit 205 and a baseband processing unit 206. The baseband processing unit 206 may be electrically connected to the antenna 201 through the radio frequency processing unit 205. In some embodiments, the radio frequency processing unit 205 may also be referred to as a remote radio unit (remote radio unit, RRU), and the baseband processing unit 206 may also be referred to as a baseband unit (baseband unit, BBU). The radio frequency processing unit 205 and the baseband processing unit 206 may be electrically connected through a transmission line 207.

It should be noted that FIG. 2 merely shows an example of a position relationship between the radio frequency processing unit 205 and the antenna 201. In some other embodiments, both the radio frequency processing unit 205 and the baseband processing unit 206 may be located at a remote end of the antenna 201.

The antenna 201 is a device for connecting a radio frequency front end of a wireless network to the terminal 102, and is mainly configured to implement cell coverage of a radio signal. Specifically, the antenna 201 is an information and energy converter between the base station 101 and the terminal 102, and is configured to convert modulated radio frequency current energy into electromagnetic wave energy for transmission, and is configured to receive electromagnetic wave energy and effectively convert the electromagnetic wave energy into radio frequency current energy and transmit the radio frequency current energy to a main device. Therefore, the base station 101 may send a signal to the terminal 102 through the antenna 201, or receive, through the antenna 201, a signal sent by the terminal 102.

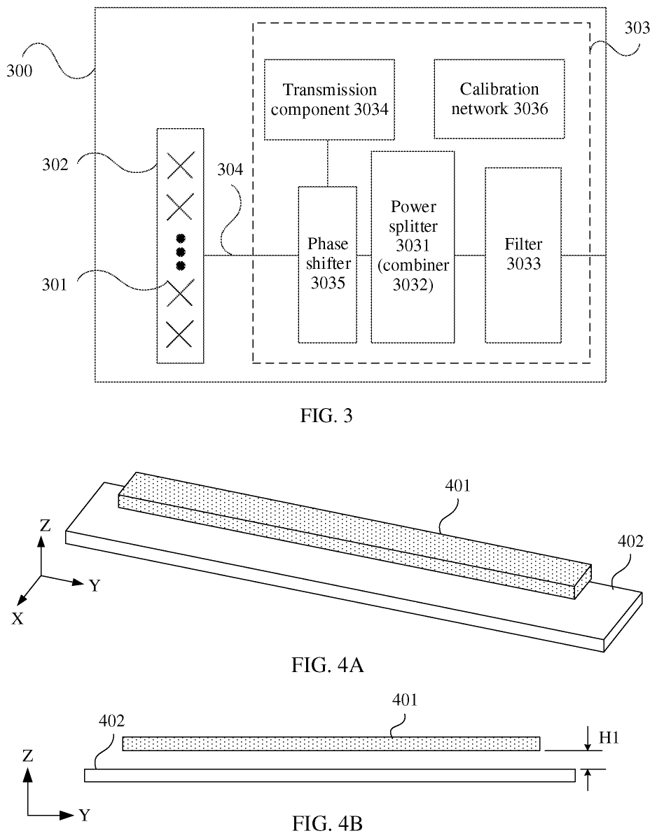

FIG. 3 is a block diagram of a structure of an antenna according to an embodiment of this application. It may be understood that the antenna 300 shown in FIG. 3 may be a specific example of the antenna 201 shown in FIG. 2.

As shown in FIG. 3, the antenna 300 may include a radiation element 301, a reflector 302, and a feed network 303. The radiation element 301 may be a unit that constitutes a radiation element array, and can effectively radiate and/or receive an antenna signal. Frequencies of different radiation elements 301 may be the same or different. The reflector 302 is configured to restrict directionality. The radiation element 301 is usually disposed on one side of the reflector 302. The feed network 303 is located between the radiation element 301 and a power amplifier of the radio frequency processing unit 205 shown in FIG. 2. The feed network 303 may feed the radiation element 301 through the transmission line 304, for example, provide specific power and a specific phase for the radiation element 301. The feed network 303 usually includes controlled impedance transmission lines.

Refer to FIG. 3. In some embodiments, the feed network 303 may include a power divider 3031 (or a combiner 3032) that can be used in a forward direction or in a reverse direction and is configured to split one signal into a plurality of signals or combine a plurality of signals into one signal. The feed network 303 may further include a filter 3033, configured to filter out an interference signal. For a remote electrical tilt antenna, the feed network 303 may further include a transmission component 3034 and a phase shifter 3035. The transmission component 3034 is configured to implement different radiation beam directions, and the phase shifter 3035 is configured to change a maximum signal radiation direction. In some cases, the phase shifter 3035 may further have a function of the power divider 3031 (or the combiner 3032), so that the power divider 3031 (or the combiner 3032) may be omitted in the feed network 303.

In some embodiments, the feed network 303 may further include a calibration network 3036, to obtain a needed calibration signal.

In embodiments of this application, different components included in the feed network 303 may be electrically connected to each other through a transmission line and a connector.

It should be noted that the power divider 3031 (or the combiner 3032) may be located inside or outside the radome 204 shown in FIG. 2. In addition, electrical connection relationships between the foregoing different components are not unique. FIG. 3 merely schematically shows a possible position relationship between the components and an electrical connection manner.

The transmission line (transmission line) is a wire or a conductor system with specific parameters and a characteristic impedance. A basic structure of the transmission line includes an inner conductor and a ground, where the inner conductor and the ground form a capacitance. A main function of the transmission line is to transmit a signal and energy from one place to another place, and maintain signal quality during the transmission. In a wireless communication system, the transmission line may be applied to components for transmitting energy and signals, such as a feed line, a phase shifter, a combiner, and a balun. The transmission line may also connect components that need to transmit energy and signals. For example, the phase shifter is connected to an antenna element, the phase shifter is connected to an RRU, the combiner is connected to the phase shifter, and the filter is connected to the combiner. Therefore, the transmission line is required not only to be capable of transmitting signals, but also to ensure stability of signal transmission. Therefore, quality and performance of the transmission line play a vital role in stability and reliability of the communication system.

Generally, a stable impedance of the transmission line can ensure stability and reliability of signal transmission. In the principle of the transmission line, a value of a capacitance between the inner conductor and the ground is an important part of the impedance of the transmission line. Therefore, whether the value of the capacitance between the inner conductor and the ground is stable directly affects stability of the impedance of the transmission line. In other words, to ensure that the impedance of the transmission line does not change, it is necessary to ensure that the capacitance between the inner conductor and the ground remains stable.

A formula for calculating the capacitance between the inner conductor and the ground may be as follows:

C=εS/4πkd
where ε is a constant, S is an overlapping area (namely, a coupling area, or also referred to as a capacitance area) between the inner conductor and the ground, d is a distance between the inner conductor and the ground, and k is the Coulomb constant.

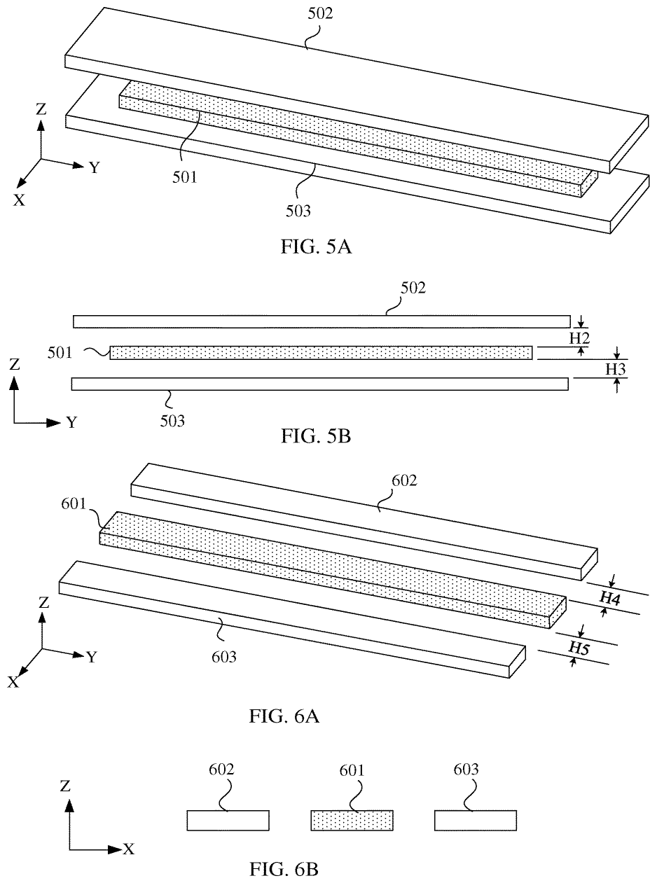

Currently, the following several structures are commonly used for transmission lines: a microstrip line, a stripline, and a coplanar line (the following uses a coplanar stripline as an example). The following provides descriptions with reference to FIG. 4A to FIG. 6B.

For ease of description, the following defines a direction parallel to the thickness of the ground as a Z direction, a direction parallel to the length of the ground as a Y direction, and a direction parallel to the width of the ground as an X direction. The X direction is perpendicular to the Y direction, and the Z direction is perpendicular to both the X direction and the Y direction. Herein, definitions of the X, Y, and Z directions are also applicable to the accompanying drawings to be described below. It should be noted that the definitions of the X, Y, and Z directions are merely intended to facilitate description of a position relationship and a connection relationship between components in embodiments of this application, and should not be construed as a limitation on embodiments of this application.

For ease of description and understanding, in embodiments of this application, a dimension parallel to the Z direction may be referred to as the vertical dimension, and a dimension perpendicular to the Z direction may be referred to as the horizontal dimension.

FIG. 4A and FIG. 4B are diagrams of a structure of a microstrip line. FIG. 4A and FIG. 4B are respectively three-dimensional diagrams of the microstrip line from different perspectives. As shown in FIG. 4A and FIG. 4B, the microstrip line includes an inner conductor 401 and a ground 402, and the inner conductor 401 and the ground 402 are stacked in a Z direction. Specifically, a thickness direction of the inner conductor 401 is the same as a thickness direction of the ground 402 (referring to the Z direction shown in FIG. 4A and FIG. 4B), and a plane on which a main surface (that is, a surface with the largest area on the inner conductor 401) of the inner conductor 401 is located is parallel to a plane on which a main surface (that is, a surface with the largest area on the ground 402) of the ground 402 is located (referring to an XY plane shown in FIG. 4A and FIG. 4B). In other words, in the microstrip line, a layer at which the inner conductor 401 is located is parallel to a layer at which the ground 402 is located. It may be understood that, a dielectric layer (not shown in FIG. 4A and FIG. 4B), for example, a dielectric substrate or another dielectric, is further disposed between the inner conductor 401 and the ground 402. The inner conductor 401 and the ground 402 are respectively disposed on two sides of the dielectric layer in a thickness direction (referring to the Z direction shown in FIG. 4A and FIG. 4B).

Refer to FIG. 4A and FIG. 4B. In the microstrip line, the inner conductor 401 and the ground 402 form a capacitance. The ground 402 and a wide surface of the inner conductor 401 are coupled to form a transmission line capacitance, and a distance between the inner conductor 401 and the ground 402 is H1. It can be learned from the capacitance calculation formula that, when a relative position between the inner conductor 401 and the ground 402 changes in the horizontal dimension, a coupling area between the ground 402 and the inner conductor 401 does not change. Therefore, the capacitance formed by the inner conductor 401 and the ground 402 is stable. When the relative position between the inner conductor 401 and the ground 402 changes in the vertical dimension, the distance H1 between the inner conductor 401 and the ground 402 changes, and the capacitance formed by the inner conductor 401 and the ground 402 changes sharply accordingly. As a result, an impedance of the microstrip line changes sharply. In other words, the value of the capacitance between the inner conductor 401 and the ground 402 is sensitive to changes in the distance H1 between the inner conductor 401 and the ground 402, resulting in a poor tolerance capability (or referred to as a poor tolerance robustness capability) of the impedance of the microstrip line in the vertical dimension.

FIG. 5A and FIG. 5B are diagrams of a structure of a stripline. FIG. 5A and FIG. 5B are respectively three-dimensional diagrams of the stripline from different perspectives. As shown in FIG. 5A and FIG. 5B, the stripline includes an inner conductor 501, a first ground 502, and a second ground 503. The inner conductor 501, the first ground 502, and the second ground 503 are stacked in a Z direction, and the inner conductor 501 is disposed between the first ground 502 and the second ground 503. Specifically, refer to the Z direction shown in FIG. 5A and FIG. 5B. A thickness direction of the inner conductor 501, a thickness direction of the first ground 502, and a thickness direction of the second ground 503 are the same. Refer to an XY plane shown in FIG. 5A and FIG. 5B. A layer at which the inner conductor 501 is located, a layer at which the first ground 502 is located, and a layer at which the second ground 503 is located are parallel to each other. It may be understood that, a dielectric layer (not shown in FIG. 5A and FIG. 5B), for example, air or another dielectric, is further disposed between the inner conductor 501 and the first ground 502 and between the inner conductor 501 and the second ground 503.

Refer to FIG. 5A and FIG. 5B. In the stripline, the inner conductor 501 and the first ground 502 form a first capacitance, and the inner conductor 501 and the second ground 503 form a second capacitance. A capacitance value corresponding to the stripline is a sum of a capacitance value of the first capacitance and a capacitance value of the second capacitance. The first ground 502 is coupled to a wide surface of the inner conductor 501, and the second ground 503 is coupled to a wide surface of the inner conductor 501, to form a transmission line capacitance. A distance between the inner conductor 501 and the first ground 502 is H2, and a distance between the inner conductor 501 and the second ground 503 is H3. It can be learned from the capacitance calculation formula that, using the first capacitance as an example, when a relative position between the inner conductor 501 and the first ground 502 changes in the horizontal dimension, a coupling area between the inner conductor 501 and the first ground 502 does not change. Therefore, the first capacitance is stable. When the relative position between the inner conductor 501 and the first ground 502 changes in the vertical dimension, the distance H2 between the inner conductor 501 and the first ground 502 changes, and the first capacitance changes sharply accordingly. As a result, an impedance of the stripline changes sharply. Similarly, when a relative position between the inner conductor 501 and the second ground 503 changes in the horizontal dimension, the second capacitance is stable. When the relative position between the inner conductor 501 and the second ground 503 changes in the vertical dimension, the second capacitance changes sharply. As a result, the impedance of the stripline changes sharply. In other words, the impedance of the stripline is sensitive to changes in the distance H2 between the inner conductor 501 and the first ground 502 and changes in the distance H3 between the inner conductor 501 and the second ground 503, resulting in a poor tolerance capability (or referred to as a poor tolerance robustness capability) of the impedance of the stripline in the vertical dimension.

FIG. 6A and FIG. 6B are diagrams of a structure of a coplanar line. FIG. 6A and FIG. 6B are respectively three-dimensional diagrams of the coplanar line from different perspectives. As shown in FIG. 6A and FIG. 6B, for example, the coplanar line is a coplanar stripline. The coplanar stripline includes an inner conductor 601, a first ground 602, and a second ground 603. The inner conductor 601, the first ground 602, and the second ground 603 are located at a same layer, and the inner conductor 601 is located between the first ground 602 and the second ground 603. Specifically, refer to a Z direction shown in FIG. 6A and FIG. 6B. A thickness direction of the inner conductor 601, a thickness direction of the first ground 602, and a thickness direction of the second ground 603 are the same. Refer to an XY plane shown in FIG. 6A and FIG. 6B. The inner conductor 601, the first ground 602, and the second ground 603 are located at a same layer. It may be understood that, a dielectric layer (not shown in FIG. 6A and FIG. 6B), for example, air or another dielectric, is further disposed between the inner conductor 601 and the first ground 602 and between the inner conductor 601 and the second ground 603.

Refer to FIG. 6A and FIG. 6B. In the coplanar stripline, the inner conductor 601 and the first ground 602 form a first capacitance, and the inner conductor 601 and the second ground 603 form a second capacitance. A capacitance value corresponding to the coplanar stripline is a sum of a capacitance value of the first capacitance and a capacitance value of the second capacitance. Specifically, a value of the first capacitance depends on a thickness of the inner conductor 601, a thickness of the first ground 602, and a distance H4 between the inner conductor 601 and the first ground 602, and a value of the second capacitance depends on the thickness of the inner conductor 601, a thickness of the second ground 603, and a distance H5 between the inner conductor 601 and the second ground 603. It can be learned from the capacitance calculation formula that, when a position of the inner conductor 601 changes in an X direction, the distance H4 between the inner conductor 601 and the first ground 602 and the distance H5 between the inner conductor 601 and the second ground 603 change. However, the two distances may compensate for each other. To be specific, when a relative position between the first ground 602 and the second ground 603 remains unchanged, if H4 increases, H5 decreases, or if H4 decreases, H5 increases. Changes in the distances causes the capacitance value of the first capacitance and the capacitance value of the second capacitance to change, but the sum of the capacitance value of the first capacitance and the capacitance value of the second capacitance is stable. When a relative position between the inner conductor 601 and the first ground 602 and/or between the inner conductor 601 and the second ground 603 changes in the vertical dimension, for example, a size tolerance error occurs between the inner conductor 601 and a ground (for example, the first ground 602 or the second ground 603) in the vertical dimension, a coupling area between the inner conductor 601 and the first ground 602 and/or a coupling area between the inner conductor 601 and the second ground 603 change/changes. Changes in positions of the inner conductor 601, the first ground 602, and the second ground 603 in the vertical dimension cause a sharp change in a capacitance value of the first capacitance and/or a capacitance value of the second capacitance, and further causes a sharp change in an impedance of the coplanar stripline. In other words, the impedance of the coplanar line is sensitive to the changes in the positions of the inner conductor 601, the first ground 602, and the second ground 603 in the vertical dimension. Therefore, the impedance of the coplanar line has a poor tolerance capability (or referred to as a poor tolerance robustness capability) in the vertical dimension.

In conclusion, an impedance of an existing transmission line is sensitive to changes in positions of the inner conductor and the ground in the vertical dimension. For example, when the relative position between the inner conductor and the ground in the vertical dimension changes due to factors such as processing and/or assembly, a coupling area or spacing between the inner conductor and the ground is affected. As a result, a capacitance formed between the inner conductor and the ground changes sharply, and the impedance of the transmission line changes sharply. To ensure stability of the impedance of the transmission line, stability of the capacitance formed between the inner conductor and the ground needs to be maintained. Further, smaller changes in the positions of the inner conductor and the ground in the vertical dimension, that is, smaller tolerances, are required. This requires a higher precision processing technique and/or a higher-cost transmission line fastening solution.

In view of this, this application provides a transmission line, to reduce sensitivity of an impedance of the transmission line to changes in a relative position between the inner conductor and the ground, and improve a tolerance capability (or a tolerance robustness capability) of the transmission line.

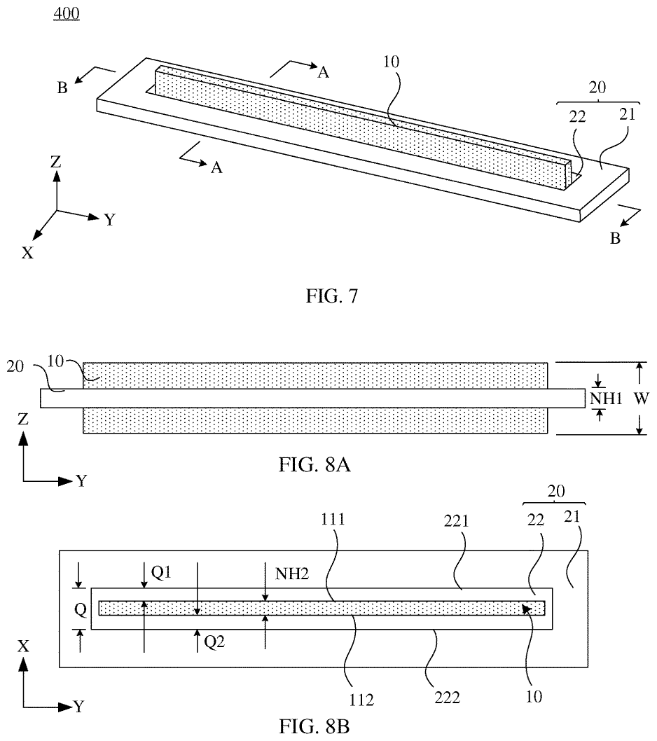

FIG. 7 is a diagram of a structure of a transmission line according to an embodiment of this application.

As shown in FIG. 7, the transmission line 400 includes an inner conductor 10 and a ground 20, where the ground 20 includes a slot hole 22 extending through a thickness of the ground 20, the inner conductor 10 is disposed in the slot hole 22, and a thickness direction of the inner conductor 10 intersects with a thickness direction of the ground 20. For ease of description, in some embodiments, the thickness direction of the ground 20 may be referred to as a first direction.

In embodiments of this application, the inner conductor 10 is disposed in the slot hole 22, and the thickness direction of the inner conductor 10 intersects with the thickness direction of the ground 20. In this way, a surface of the inner conductor 10 in the thickness direction may form a capacitance with an inner wall of the slot hole 22. When a relative position between the inner conductor 10 and the ground 20 in the vertical dimension and/or the horizontal dimension changes, impact on the capacitance formed between the inner conductor 10 and the ground 20 is small. In this way, stability of the capacitance can be maintained, stability of an impedance of the transmission line can be ensured, and stability and reliability of a signal transmitted through the transmission line can be further ensured.

For example, as shown in FIG. 7, the ground 20 may include a substrate 21 and the slot hole 22 provided on the substrate 21, where the slot hole 22 runs through the thickness of the ground 20, that is, runs through a thickness of the substrate 21, or the slot hole 22 connects two surfaces of the substrate 21 in a thickness direction of the substrate 21.

In some embodiments, inner walls of the slot hole 22 are continuous and head-to-tail connected. In other words, the inner walls of the slot hole 22 are disposed around the inner conductor 10. In this way, an energy return path can be formed between the inner conductor 10 and the ground 20, and this helps reduce impact of a distance between the inner conductor 10 and the inner wall of the slot hole 22 on the impedance of the transmission line.

In some embodiments, the inner conductor 10 is configured to provide a signal path, and the ground 20 is configured to provide a return path.

In embodiments of this application, the ground 20 is made of a conductive material, for example, a metal material. For example, the ground 20 may be a metal plate.

In embodiments of this application, the inner conductor 10 is made of a conductive material, for example, a metal material. For example, the inner conductor 10 may be a metal stripline. FIG. 8A and FIG. 8B are a schematic front view and a schematic top view of the transmission line 400 in FIG. 7. The following describes in detail an operating principle of the transmission line provided in embodiments of this application with reference to FIG. 8A and FIG. 8B.

FIG. 8A is the schematic front view of the transmission line 400. Refer to FIG. 8A. The thickness of the ground 20 is schematically represented as NH1, and a width of the inner conductor 10 is schematically represented as W. Generally, the width W of the inner conductor 10 is much greater than a thickness of the inner conductor 10 (refer to a parameter NH2 shown in FIG. 8B). Therefore, the surface of the inner conductor 10 in the thickness direction is much larger than other surfaces. For ease of description, the surface is referred to as a wide surface in embodiments of this application. Generally, the thickness NH2 of the inner conductor 10 is approximately equal to the thickness NH1 of the ground 20. Therefore, as shown in FIG. 8A, the width W of the inner conductor 10 is much greater than the thickness NH1 of the ground 20, that is, the width W of the inner conductor 10 is much greater than a size of the inner wall of the slot hole 22 in the thickness direction (namely, the first direction) of the ground 20. In embodiments of this application, when the inner conductor 10 is disposed in the slot hole 22, the wide surface of the inner conductor 10 is coupled to the inner wall of the slot hole 22.

Because an area of the wide surface of the inner conductor 10 is larger than an area of the inner wall of the slot hole 22, when a relative position between the inner conductor 10 and the ground 20 in the vertical dimension (refer to a Z direction shown in FIG. 8A) changes, for example, the inner conductor 10 moves relative to the ground 20 in the vertical dimension, or there is a tolerance in a size of the inner conductor 10 and/or a size of the ground 20 in the vertical dimension, a coupling area between the inner conductor 10 and the ground 20 may remain unchanged, that is, an overlapping area between the wide surface of the inner conductor 10 and the inner wall of the slot hole 22 remains unchanged. Therefore, stability of a capacitance between the inner conductor 10 and the ground 20 can be maintained, and stability of the impedance of the transmission line 400 can be ensured.

In addition, in embodiments of this application, because the wide surface of the inner conductor 10 is fully used as a coupling surface, a coupling capacitance is greater than a coupling capacitance of a coplanar line, providing a stronger capability of binding an electromagnetic field. Therefore, a transmission loss can be reduced.

FIG. 8B is the schematic top view of the transmission line 400. Refer to FIG. 8B. The thickness of the inner conductor 10 is schematically represented as NH2. The inner conductor 10 includes a first surface 111 and a second surface 112 in the thickness direction of the inner conductor 10. The first surface 111 and the second surface 112 are disposed opposite to each other. The inner wall of the slot hole 22 includes a first wall 221 facing the first surface 111 and a second wall 222 facing the second surface 112. In other words, the first surface 111 of the inner conductor 10 is disposed opposite to the first wall 221 of the slot hole 22, and the second surface 112 of the inner conductor 10 is disposed opposite to the second wall 222 of the slot hole 22. Therefore, the capacitance formed between the inner conductor 10 and the ground 20 includes a first capacitance formed by coupling the first surface 111 and the first wall 221, and a second capacitance formed by coupling the second surface 112 and the second wall 222. As shown in FIG. 8B, a gap (namely, a width of the slot hole 22) between the first wall 221 and the second wall 222 is schematically represented as Q, a gap between the first wall 221 and the first surface 111 is schematically represented as Q1, and a gap between the second wall 222 and the second surface 112 is schematically represented as Q2. The thickness NH2 of the inner conductor 10 is less than the width Q of the slot hole 22. Therefore, the inner conductor 10 may be inserted into the slot hole 22 to form a transmission line.

When the width Q of the slot hole 22 is fixed, when the relative position between the inner conductor 10 and the ground 20 in the horizontal dimension (for example, refer to an X direction shown in FIG. 8A) changes, for example, the inner conductor 10 moves relative to the ground 20 in a width direction of the slot hole 22, or there is a tolerance in an assembly size of the inner conductor 10 and/or an assembly size of the ground 20 in the horizontal dimension, the gap Q1 that affects a value of the first capacitance and the gap Q2 that affects a value of the second capacitance may compensate for each other, so that a sum of a capacitance value of the first capacitance and a capacitance value of the second capacitance remains unchanged, that is, a value of the capacitance formed between the inner conductor 10 and the ground 20 remains unchanged. Therefore, stability of a capacitance between the inner conductor 10 and the ground 20 can be maintained, and stability of the impedance of the transmission line 400 can be ensured.

For example, when the inner conductor 10 moves relative to the ground 20 in the width direction of the slot hole 22, the distance Q1 between the inner conductor 10 and the first wall 221 of the slot hole 22 and the distance Q2 between the inner conductor 10 and the second wall 222 of the slot hole 22 change, but the distances on both sides may compensate for each other. Specifically, when Q1 increases, Q2 decreases; or when Q1 decreases, Q2 increases. The sum of the capacitance value of the first capacitance and the capacitance value of the second capacitance remains unchanged. Therefore, a value of the capacitance between the inner conductor 10 and the ground 20 is stable, so that the impedance of the transmission line can be kept stable when Q1 and/or Q2 change/changes.

Therefore, in the transmission line provided in embodiments of this application, the impedance of the transmission line is insensitive to changes in the relative position between the inner conductor 10 and the ground 20 in the horizontal dimension and the vertical dimension, thereby enhancing a strip line tolerance and improving a tolerance capability of the impedance of the transmission line. On the contrary, when the relative position between the inner conductor 10 and the ground 20 in the vertical dimension and/or the horizontal dimension changes, the capacitance formed between the inner conductor 10 and the ground 20 can still remain stable, thereby ensuring stability of the impedance of the transmission line and improving a tolerance robustness capability of the impedance of the transmission line. In addition, because the strip line tolerance is enhanced, the transmission line may be manufactured through a low-cost process like a sheet metal process, and does not depend on a high-precision processing technique like a printed circuit board (printed circuit board, PCB).

It should be noted that, the improvement of the tolerance capability of the impedance of the transmission line may be understood as that, under the premise that the impedance of the transmission line is stable, an error range allowed by a design size of the transmission line (for example, a design size of the inner conductor 10, a design size of the ground 20, and a parameter of assembling between the inner conductor 10 and the ground 20) is increased, that is, a tolerance is expanded. The improvement of the tolerance robustness capability of the impedance of the transmission line may be understood as that, when the transmission line varies in size due to factors such as material characteristics, processing techniques, and assembly errors, the impedance of the transmission line can still remain stable. The tolerance capability and the tolerance robustness capability of the impedance of the transmission line are merely descriptions of sensitivity of the impedance of the transmission line to the tolerance from different perspectives. In embodiments of this application, the two terms may be used interchangeably.

In embodiments of this application, the inner conductor 10 is placed in the slot hole 22 in a plurality of manners.

In a possible implementation, the inner conductor 10 is vertically inserted into the slot hole 22. Correspondingly, the thickness direction of the inner conductor 10 is perpendicular to the thickness direction of the ground 20.

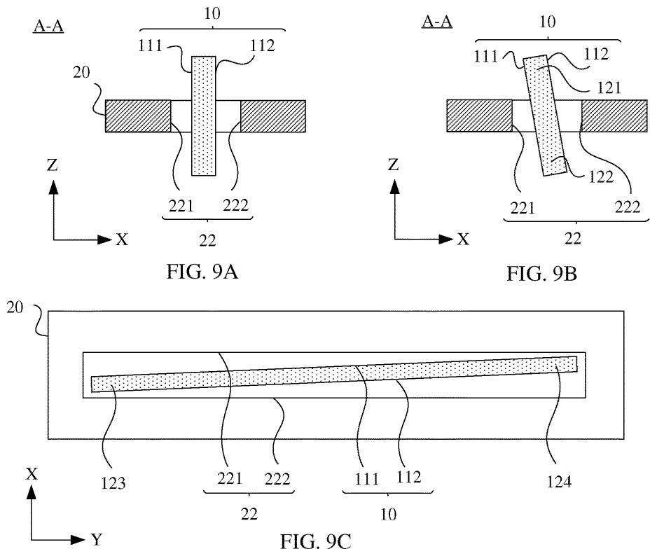

For example, FIG. 9A is a cross-sectional diagram of the transmission line 400 in FIG. 7 cut along a line A-A. As shown in FIG. 9A, the first surface 111 of the inner conductor 10 may be perpendicular to the thickness direction of the inner conductor 10, the second surface 112 of the inner conductor 10 may be perpendicular to the thickness direction of the inner conductor 10, the first wall 221 of the slot hole 22 may be parallel to the first surface 111, and the second wall 222 of the slot hole 22 may be parallel to the second surface 112. Therefore, the first surface 111, the second surface 112, the first wall 221, and the second wall 222 are parallel to each other. In this embodiment, the gap between the first wall 221 and the first surface 111 (refer to the foregoing parameter Q1) remains unchanged in the thickness direction of the ground 20, and the gap between the second wall 222 and the second surface 112 (refer to the foregoing parameter Q2) remains unchanged in the thickness direction of the ground 20.

In this way, a specific distance can always be maintained between the first surface 111 and the first wall 221 and between the second surface 112 and the second wall 222, to avoid a short circuit caused by contact between the inner conductor 10 and the ground 20, and improve reliability of the capacitance.

In another possible implementation, the inner conductor 10 is obliquely inserted into the slot hole 22. Correspondingly, the thickness direction of the inner conductor 10 intersects with the thickness direction of the ground 20, and an intersection angle is not equal to 90°.

As an example, FIG. 9B is another cross-sectional diagram of the transmission line 400 in FIG. 7 cut along the line A-A. As shown in FIG. 9B, the inner conductor 10 includes a first end 121 and a second end 122, where the first end 121 and the second end 122 are two ends of the inner conductor 10 in a width direction, one of the first end 121 and the second end 122 is close to the first wall 221, and the other is close to the second wall 222. For example, the first end 121 is close to the first wall 221, and the second end 122 is close to the second wall 222; or the first end 121 is close to the second wall 222, and the second end 122 is close to the first wall 221. Alternatively, it may be understood that, based on a state shown in FIG. 9A, the inner conductor 10 rotates around a length direction (namely, a Y-axis) of the inner conductor 10 to implement tilting, to obtain a state shown in FIG. 9B.

In another example, FIG. 9C is a schematic top view of the transmission line 400 in FIG. 7. As shown in FIG. 9C, the inner conductor 10 includes a third end 123 and a fourth end 124, where the third end 123 and the fourth end 124 are two ends of the inner conductor 10 in the length direction, one of the third end 123 and the fourth end 124 is close to the first wall 221, and the other is close to the second wall 222. For example, the third end 123 is close to the first wall 221, and the fourth end 124 is close to the second wall 222; or the third end 123 is close to the second wall 222, and the fourth end 124 is close to the first wall 221. Alternatively, it may be understood that, based on a state shown in FIG. 9A, the inner conductor 10 rotates around the width direction (namely, a Z-axis) of the inner conductor 10 to implement tilting, to obtain a state shown in FIG. 9C.

In still another example, with reference to FIG. 9B and FIG. 9C, both the tilt manner shown in FIG. 9B and the tilt manner shown in FIG. 9C may be used for the inner conductor 10. In other words, based on the state shown in FIG. 9A, the inner conductor 10 rotates around both the length direction and the width direction of the inner conductor 10.

In another possible implementation, the two ends of the inner conductor 10 in the length direction are flush.

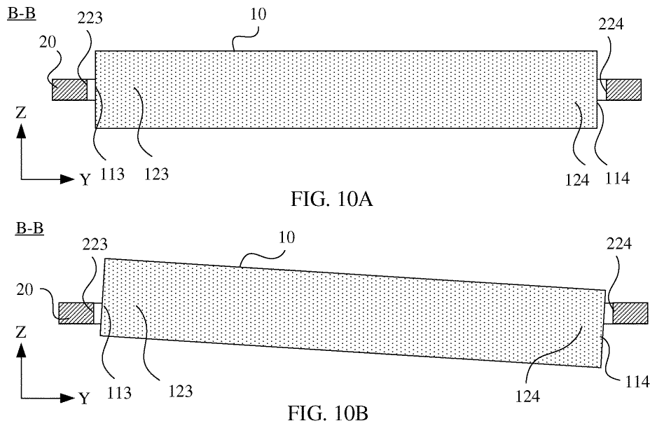

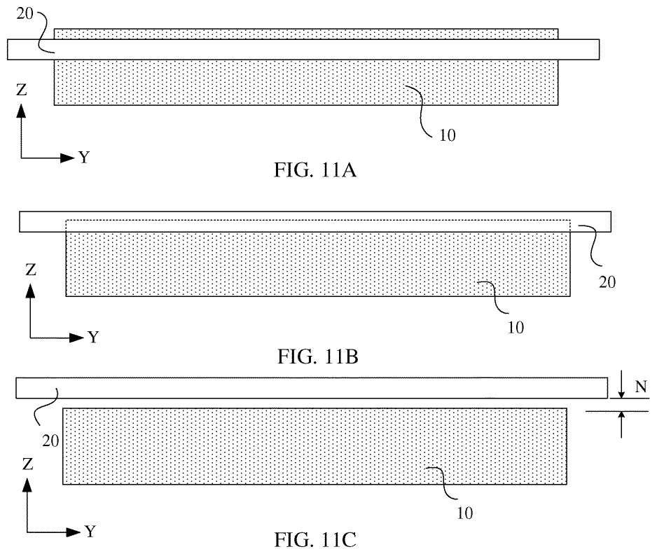

For example, FIG. 10A is a cross-sectional diagram of the transmission line 400 in FIG. 7 cut along a line B-B. As shown in FIG. 10A, the inner conductor 10 includes a third end 123 and a fourth end 124, where the third end 123 and the fourth end 124 are two ends of the inner conductor 10 in the length direction. A gap between the third end 123 and a wall of the slot hole 22 facing the third end 123 remains unchanged in the thickness direction of the ground 20, and a gap between the fourth end 124 and a wall of the slot hole 22 facing the fourth end 124 remains unchanged in the thickness direction of the ground 20. As an example rather than a limitation, as shown in FIG. 10A, the wall of the slot hole 22 facing the third end 123 is a third wall 223, the wall of the slot hole 22 facing the fourth end 124 is a fourth wall 224, a surface of the third end 123 facing the third wall 223 is a third surface 113, and a surface of the fourth end 124 facing the fourth wall 224 is a fourth surface 114. The third wall 223, the fourth wall 224, the third surface 113, and the fourth surface 114 may be parallel to each other. A gap between the third wall 223 and the third surface 113 remains unchanged in the thickness direction of the ground 20, and a gap between the fourth wall 224 and the fourth surface 114 remains unchanged in the thickness direction of the ground 20.

In another possible implementation, the two ends of the inner conductor 10 in the length direction are not flush.

For example, FIG. 10B is another cross-sectional diagram of the transmission line 400 in FIG. 7 cut along a line B-B. As shown in FIG. 10B, the inner conductor 10 includes a third end 123 and a fourth end 124, where the third end 123 and the fourth end 124 are two ends of the inner conductor 10 in the length direction. A gap between the third end 123 and a wall (namely, a third wall 223) of the slot hole 22 facing the third end 123 gradually changes in the thickness direction of the ground 20, and a gap between the fourth end 124 and a wall (namely, a fourth wall 224) of the slot hole 22 facing the fourth end 124 gradually changes in the thickness direction of the ground 20. As an example rather than a limitation, as shown in FIG. 10B, a surface of the third end 123 facing the third wall 223 is a third surface 113, and a surface of the fourth end 124 facing the fourth wall 224 is a fourth surface 114. A gap between the third wall 223 and the third surface 113 gradually changes in the thickness direction of the ground 20, and a gap between the fourth wall 224 and the fourth surface 114 gradually changes in the thickness direction of the ground 20. Alternatively, it may be considered that, a part of the third surface 113 is close to the third wall 223, and the other part is far away from the third wall 223; and a part of the fourth surface 114 is close to the fourth wall 224, and the other part is far away from the fourth wall 224. Alternatively, it may be understood that, based on a state shown in FIG. 10A, the inner conductor 10 rotates around the thickness direction (namely, an X-axis) of the inner conductor 10 to obtain a state shown in FIG. 10B.

In some other embodiments, when there is no contradiction, a placement manner of the inner conductor 10 shown in FIG. 9A to FIG. 9C may be combined with a placement manner of the inner conductor 10 shown in FIG. 10A and FIG. 10B. Details are not described herein again.

It may be understood that, when the inner conductor 10 is in the state shown in FIG. 9B, the state shown in FIG. 9C, or the state shown in FIG. 10B, although the inner conductor 10 is tilted, in the horizontal dimension, the gap between the first surface 111 and the first wall 221 and the gap between the second surface 112 and the second wall 222 may compensate for each other, so that a value of a capacitance between the inner conductor 10 and the ground 20 remains stable, and an impedance of the transmission line can also be stable. In the vertical dimension, when the inner conductor 10 is misaligned with the ground 20, provided that the inner conductor 10 is not completely moved out of a range of the slot hole 22, a coupling area between the inner conductor 10 and the ground 20 does not change, and a size tolerance in this dimension has negligible impact on the impedance of the transmission line.

In embodiments of this application, the inner conductor 10 may move relative to the ground 20 in the thickness direction of the ground 20.

For example, refer to FIG. 8A. A projection of the ground 20 in a second direction is located at a position approximately in the middle of a projection of the inner conductor 10 in the second direction. Herein, the second direction is a width direction of the ground 20. For example, the projection of the ground 20 in the second direction divides the projection of the inner conductor 10 in the second direction into two equal parts.

For another example, refer to FIG. 11A. A projection of the ground 20 in a second direction deviates from a center line of a projection of the inner conductor 10 in the second direction. For example, the projection of the ground 20 in the second direction divides the projection of the inner conductor 10 in the second direction into two unequal parts.

For another example, refer to FIG. 11B. One end (for example, the first end 121 or the second end 122) of the inner conductor 10 in the width direction of the inner conductor 10 is located in the slot hole 22. For example, the projection of the first end 121 or the second end 122 in the second direction overlaps with a projection of the ground 20 in the second direction.

In the foregoing embodiments, the inner conductor 10 is disposed in the slot hole 22. The inner conductor 10 may be completely inserted into the slot hole 22, or a part of the inner conductor 10 is inserted into the slot hole 22. In this way, there is a directly overlapping coupling area between the inner conductor 10 and the inner wall of the slot hole 22, a coupling field is stronger, and a capability of binding an electric field is stronger, so that a transmission loss of the transmission line can be reduced.

Refer to FIG. 11C. In some other embodiments, the inner conductor 10 may deviate from the slot hole 22, or the inner conductor 10 is not completely inserted into the slot hole 22. In other words, the projection of the inner conductor 10 in the second direction does not overlap the projection of the ground 20 in the second direction. In this case, provided that a distance by which the inner conductor 10 deviates from the slot hole 22 is within a specific range (for example, a tolerance range), a capacitance can still be formed between the inner conductor 10 and the ground 20 to transmit energy.

Refer to FIG. 11C. In some embodiments, in the thickness direction of the ground 20, a gap N between the inner conductor 10 and the ground 20 is less than or equal to 0.1 operating wavelengths.

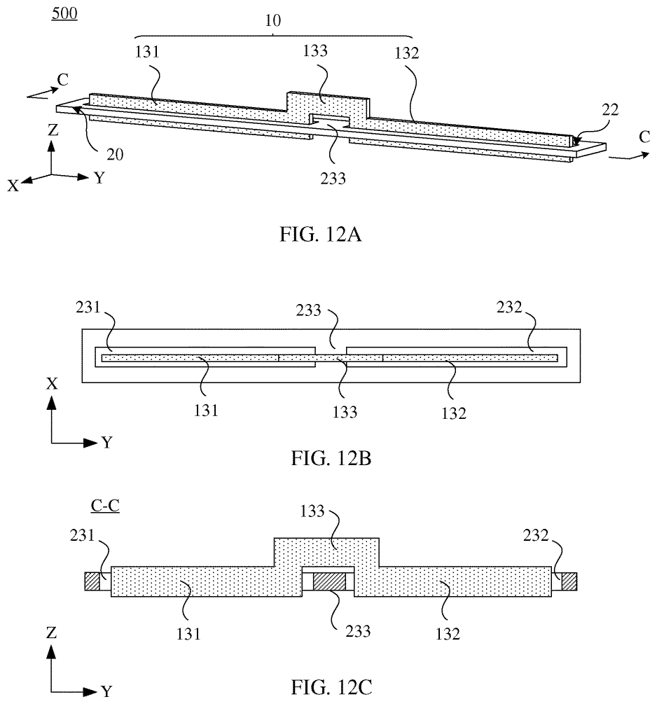

FIG. 12A to FIG. 12C are diagrams of a structure of another transmission line according to an embodiment of this application. FIG. 12A is a three-dimensional diagram of a transmission line 500, FIG. 12B is a schematic top view of the transmission line 500, and FIG. 12C is a cross-sectional diagram of the transmission line 500 cut along a line C-C.

Refer to FIG. 12A to FIG. 12C. The transmission line 500 includes the inner conductor 10 and the ground 20, where the ground 20 includes the slot hole 22 extending through a thickness of the ground 20, a part of the inner conductor 10 is disposed in the slot hole 22, and a thickness direction of the inner conductor 10 intersects with a thickness direction of the ground 20.

Specifically, the slot hole 22 includes a first slot section 231 and a second slot section 232 that are arranged in a length direction of the ground 20 (for ease of description, referred to as a third direction in the following embodiments), and the first slot section 231 is not connected to the second slot section 232, or in other words, the first slot section 231 and the second slot section 232 are spaced apart. The inner conductor 10 includes a first part 131, a second part 132, and a third part 133 configured to connect the first part 131 and the second part 132. The first part 131 is disposed in the first slot section 231, the second part 132 is disposed in the second slot section 232, and the third part 133 is located outside the slot hole 22 and is not in contact with a ground part 233 (for ease of description, referred to as a connecting part 233 below) between the first slot section 231 and the second slot section 232. Alternatively, it may be understood that a projection of the first part 131 in the thickness direction of the ground 20 overlaps with a projection of the first slot section 231 in the thickness direction of the ground 20. A projection of the second part 132 in the thickness direction of the ground 20 overlaps with a projection of the second slot section 232 in the thickness direction of the ground 20. At least a part of a projection of the third part 133 in the thickness direction of the ground 20 is located outside the projection range of the first slot section 231 in the thickness direction of the ground 20, and is located outside the projection range of the second slot section 232 in the thickness direction of the ground 20.

In this embodiment, the first part 131 of the inner conductor 10 and the first slot section 231 form a capacitance, the second part 132 of the inner conductor 10 and the second slot section 232 form a capacitance, and the connecting part 233 of the ground 20 is a short-circuit point between the first slot section 231 and the second slot section 232. Therefore, the third part 133 of the inner conductor 10 jumps over the short-circuit point. The third part 133 and the ground 20 (which may be specifically the connecting part 233) form a microstrip line, and energy is well bounded, so that an impedance of the transmission line can be continuous.

It may be understood that FIG. 12A to FIG. 12C merely schematically indicate that the slot hole 22 is divided into two slot sections. In some other embodiments, the slot hole 22 may be alternatively divided into more slot sections. This is not limited in embodiments of this application.

In embodiments of this application, the slot hole 22 provided on the ground 20 is divided into a plurality of slot sections, and all the plurality of slot sections may be used to transmit energy. Adjacent slot sections in the plurality of slot sections are connected through the connecting part 233. In other words, the slot hole 22 is discontinuous. In this way, strength of the ground 20 can be improved without affecting performance of the transmission line.

It may be understood that, in the descriptions of the transmission line 400, related optional embodiments may be applicable to the transmission line 500. For details, refer to the foregoing related descriptions. For brevity, details are not described herein again.

In some embodiments, as shown in FIG. 7 to FIG. 12C, parts of the inner conductor 10 may have a same thickness direction. The transmission line 500 shown in FIG. 12A to FIG. 12C is used as an example. A thickness direction of the first part 131, a thickness direction of the second part 132, and a thickness direction of the third part 133 are the same. The thickness direction of the third part 133 intersects with a thickness direction of the connecting part 233 (namely, the thickness direction of the ground 20). For example, the thickness direction of the third part 133 may be perpendicular to the thickness direction of the connecting part 233. In this way, the thickness directions of the parts of the inner conductor 10 are unified, a processing technique is simple, and costs are low.

In some embodiments, parts of the inner conductor 10 may have different thickness directions, that is, the inner conductor 10 may be bent.

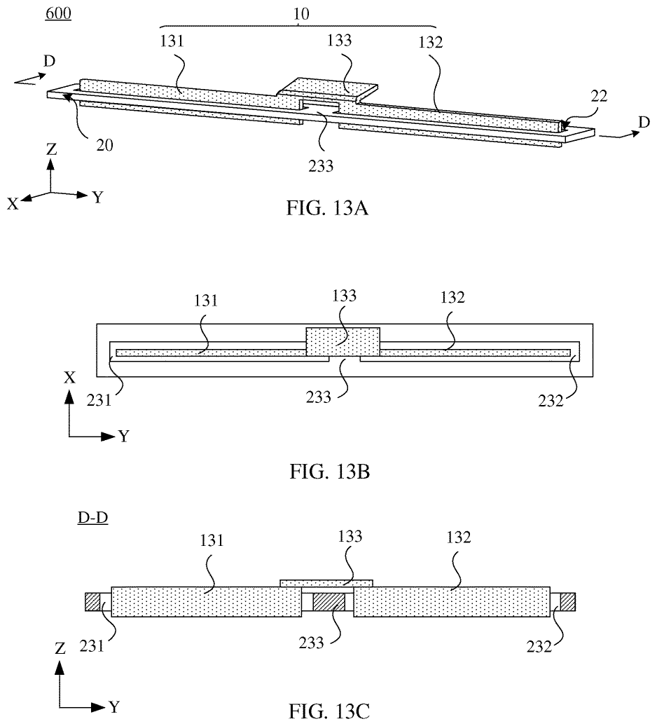

FIG. 13A to FIG. 13C are diagrams of a structure of another transmission line according to an embodiment of this application. FIG. 13A is a three-dimensional diagram of a transmission line 600, FIG. 13B is a schematic top view of the transmission line 600, and FIG. 13C is a cross-sectional diagram of the transmission line 600 cut along a line D-D.

The structure of the transmission line 600 shown in FIG. 13A to FIG. 13C is similar to the structure of the transmission line 500 shown in FIG. 12A to FIG. 12C. The following describes only differences between the transmission line 600 and the transmission line 500. For other content, refer to related content of the transmission line 500. Details are not described herein again.

Refer to in FIG. 13A to FIG. 13C. The transmission line 600 includes the inner conductor 10 and the ground 20, where the ground 20 includes the slot hole 22 extending through a thickness of the ground 20, a part of the inner conductor 10 is disposed in the slot hole 22, and a thickness direction of the part of the inner conductor 10 in the slot hole 22 intersects with a thickness direction of the ground 20. Specifically, the slot hole 22 includes the first slot section 231 and the second slot section 232 that are arranged in a length direction of the ground 20. The inner conductor 10 includes the first part 131, the second part 132, and the third part 133 configured to connect the first part 131 to the second part 132. The first part 131 is disposed in the first slot section 231, the second part 132 is disposed in the second slot section 232, and the third part 133 is located outside the slot hole 22 and is not in contact with the connecting part 233 of the ground 20.

A thickness direction of the third part 133 intersects with a thickness direction of the first part 131. The thickness direction of the third part 133 intersects with a thickness direction of the second part 132. The thickness direction of the third part 133 is parallel to a thickness direction of the connecting part 233, or it may be understood that the third part 133 is parallel to the connecting part 233.

In this way, the first part 131 of the inner conductor 10 and the first slot section 231 form a capacitance, the second part 132 of the inner conductor 10 and the second slot section 232 form a capacitance, and the third part 133 of the inner conductor 10 and the connecting part 233 form a capacitance. Because a coupling area between the third part 133 and the connecting part 233 is large, coupling between the inner conductor 10 and the ground 20 is increased as a whole, so that an impedance of the transmission line can be more continuous.

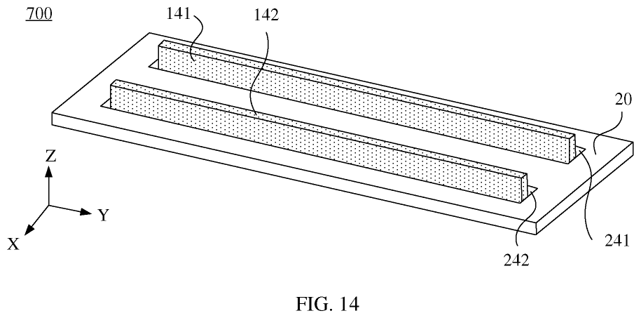

FIG. 14 is a diagram of a structure of another transmission line according to an embodiment of this application.

As shown in FIG. 14, the transmission line 700 includes a first inner conductor 141, a second inner conductor 142, and the ground 20. The ground 20 includes a first slot hole 241 and a second slot hole 242 that run through a thickness of the ground 20. The first slot hole 241 and the second slot hole 242 are arranged in a width direction of the ground 20, and the first slot hole 241 and the second slot hole 242 are spaced apart. The first inner conductor 141 is coupled to the first slot hole 241 to form a capacitance, and the second inner conductor 142 is coupled to the second slot hole 242 to form a capacitance.

In embodiments of this application, for a relative position relationship, a working principle, and the like of the first inner conductor 141 and the first slot hole 241, refer to the descriptions of the inner conductor 10 and the slot hole 22 in FIG. 7 to FIG. 13C. In other words, embodiments in FIG. 7 to FIG. 13C are also applicable to the first inner conductor 141 and the first slot hole 241, or the foregoing descriptions of the inner conductor 10 and the slot hole 22 may be directly replaced with descriptions of the first inner conductor 141 and the first slot hole 241. For brevity, details are not described herein again.

Similarly, for a relative position relationship, a working principle, and the like of the second inner conductor 142 and the second slot hole 242, refer to the descriptions of the inner conductor 10 and the slot hole 22 in FIG. 7 to FIG. 13C. In other words, embodiments in FIG. 7 to FIG. 13C are also applicable to the second inner conductor 142 and the second slot hole 242, or the foregoing descriptions of the inner conductor 10 and the slot hole 22 may be directly replaced with descriptions of the second inner conductor 142 and the second slot hole 242. For brevity, details are not described herein again.

In some embodiments, inner walls of the first slot hole 241 are continuous and head-to-tail connected, and inner walls of the second slot hole 242 are continuous and head-to-tail connected.

In some embodiments, a length direction of the first slot hole 241 is parallel to a length direction of the second slot hole 242.

In embodiments of this application, a size (for example, a width or a length) of the first slot hole 241 may be the same as or different from a corresponding size of the second slot hole 242. This is not limited in this application.

In some embodiments, a wide surface of the first inner conductor 141 is parallel to a wide surface of the second inner conductor 142.

In some embodiments, a thickness direction of the first inner conductor 141 is parallel to a thickness direction of the second inner conductor 142.

In embodiments of this application, a structure of the first inner conductor 141 may be the same as or different from a structure of the second inner conductor 142. A structure of the first slot hole 241 may be the same as or different from a structure of the second slot hole 242.

In some embodiments, coupling between the first inner conductor 141 and the first slot hole 241 is configured to transmit a first signal, and coupling between the second inner conductor 142 and the second slot hole 242 is configured to transmit a second signal.

In some embodiments, a phase of the first signal is the same as or different from a phase of the second signal.

It may be understood that FIG. 13A to FIG. 13C merely schematically indicate that two slot holes are provided side by side on the ground 20. In some other embodiments, more slot holes may be provided on the ground 20. This is not limited in embodiments of this application.

In embodiments of this application, a plurality of slot holes arranged side by side are provided on the ground 20 to construct a transmission line, so that space occupied by the transmission line in the horizontal dimension can be reduced, and integration of a plurality of signal feed lines is facilitated.

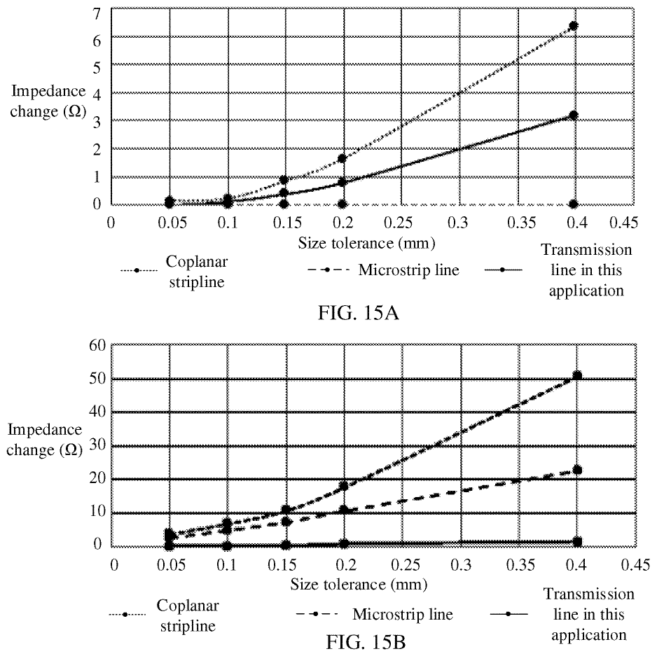

FIG. 15A and FIG. 15B are diagrams of effect comparison of impedances of several transmission lines changing with a size tolerance.

FIG. 15A is a diagram of effect comparison of the impedances of the several transmission lines changing with the horizontal dimension size tolerance. As shown in FIG. 15A, when there is a size tolerance between an inner conductor and a ground in the horizontal dimension, a tolerance robustness capability of an impedance of the microstrip line shown in FIG. 4A and FIG. 4B is the best because a capacitance between the inner conductor and the ground of the microstrip line does not change with the horizontal dimension size. The transmission line provided in this application has a stronger tolerance robustness capability than that of the coplanar line shown in FIG. 6A and FIG. 6B. When a same gap is used, a coupling capacitance between the inner conductor and the ground in the transmission line provided in this application is larger, and a coupling field is stronger. Therefore, when a horizontal gap changes, the tolerance robustness capability of the transmission line provided in this application is better than that of the coplanar line.

FIG. 15B is a diagram of effect comparison of the impedances of the several transmission lines changing with the vertical dimension size tolerance. As shown in FIG. 15B, when there is a size tolerance between the inner conductor and the ground in the vertical dimension, specifically, a change in the size H1 in the microstrip line and vertical misalignment tolerances between the inner conductor and the ground in the coplanar line and the transmission line provided in this application, the tolerance robustness capability of the impedance of the coplanar line shown in FIG. 6A and FIG. 6B is the worst because the capacitance between the inner conductor and the ground is mainly determined by a thickness of a board, and a coupling area is small and is sensitive to misalignment. In the transmission line provided in this application, the coupling capacitance between the inner conductor and the ground basically remains unchanged. Therefore, the tolerance robustness capability of the impedance of the transmission line provided in this application is the strongest.

In conclusion, the transmission line provided in this application has a good tolerance robustness characteristic in both the horizontal dimension and the vertical dimension. However, an existing transmission line has a defect that an impedance fluctuates greatly with a tolerance in one or more dimensions.

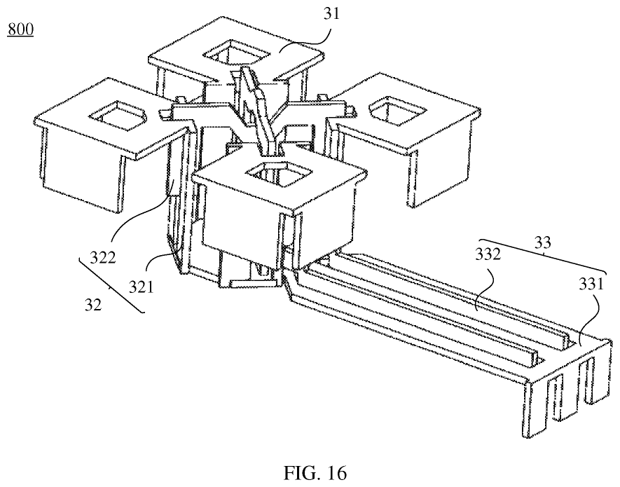

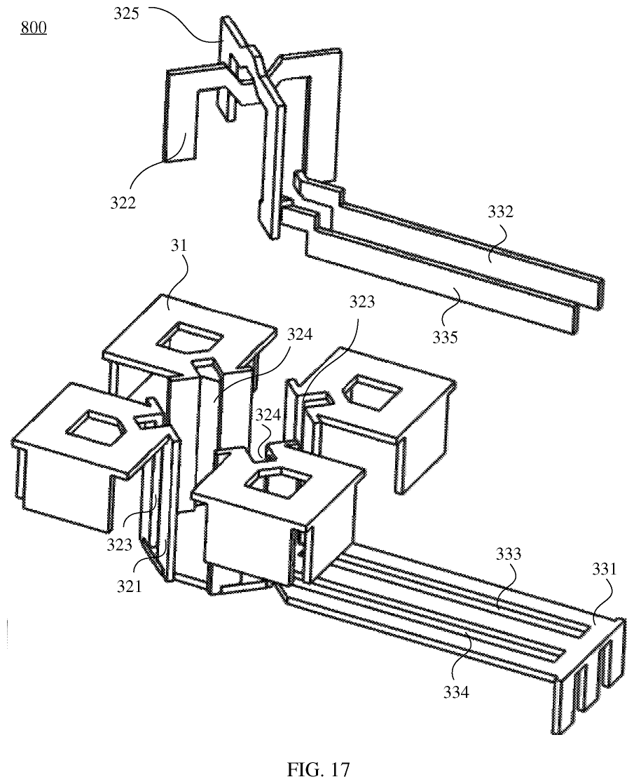

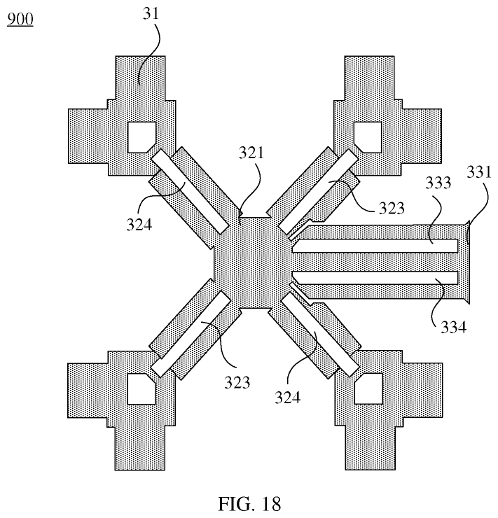

FIG. 16 and FIG. 17 are diagrams of a structure of an antenna element according to an embodiment of this application. FIG. 16 is an assembly diagram of the antenna element 800, and FIG. 17 is an exploded diagram of the antenna element 800.

Refer to FIG. 16 and FIG. 17. The antenna element 800 includes a radiator 31 and a balun 32, and the radiator 31 is electrically connected to the balun 32.

The radiator 31 is configured to receive and transmit a radio frequency signal. The radiator 31 may include a conductor having a specific shape and size, for example, a linear conductor or a sheet-like conductor. A specific shape is not limited in this application.

In some embodiments, the linear radiator may be referred to as a wire antenna for short. In an embodiment, a diameter (for example, including a thickness and a width) of a linear radiator or a radiator of a wire antenna is far less than a wavelength (for example, a medium wavelength) (for example, less than 1/16 of the wavelength), and a length may be compared with the wavelength (for example, the medium wavelength) (for example, the length is near ⅛ of the wavelength, or ⅛ to ¼, or ¼ to ½, or longer). Main forms of the wire antenna include a dipole antenna, a half-wave dipole antenna, a monopole antenna, a loop antenna, and an inverted F antenna (inverted F antenna, IFA). For example, for the dipole antenna, each dipole antenna usually includes two radiation stubs, and each stub is fed by a feeding part from a feeding end of the radiation stub. For example, the IFA antenna may be considered as being obtained by adding a ground path to a monopole antenna. The IFA antenna has a feed point and a grounding point. Because a side view of the IFA antenna is in an inverted F shape, the IFA antenna is referred to as an inverted F antenna.

In some embodiments, the sheet-like radiator may include a microstrip antenna or a patch (patch) antenna, for example, a planar inverted F antenna (planar inverted F antenna, PIFA). In an embodiment, the sheet-like radiator may be implemented by a planar conductor (for example, a conductive sheet or a conductive coating). For example, the sheet-like radiator may include a conductive sheet, for example, a copper sheet. For another example, the sheet-like radiator may include a conductive coating, for example, silver paste. A shape of the sheet-like radiator includes a circle, a rectangle, a ring, or the like. A specific shape is not limited in this application. A structure of the microstrip antenna usually includes a dielectric substrate, a radiator, and a ground, where the dielectric substrate is disposed between the radiator and the ground.

In some embodiments, the radiator may also include a slot or a slot formed on a conductor, for example, a closed or semi-closed slot or slit formed on a grounded conductor surface. In an embodiment, a radiator with a slot or a slit may be referred to as a slotted antenna or a slot antenna for short. In an embodiment, a radial size (for example, including a width) of a slot or slit of the slotted antenna/slot antenna is far less than a wavelength (for example, a medium wavelength) (for example, less than 1/16 of the wavelength), and a length size may be comparable to the wavelength (for example, the medium wavelength) (for example, the length is approximately ⅛ of the wavelength, or ⅛ to ¼, or ¼ to ½, or longer). In an embodiment, a radiator with a closed slot or slit may be referred to as a closed slot antenna for short. In an embodiment, a radiator with a semi-closed slot or slit (for example, an opening is provided on a closed slot or slit) may be referred to as an open slot antenna for short. In some embodiments, the slot is in a long strip shape. In some embodiments, a length of the slot is about half a wavelength (for example, a medium wavelength). In some embodiments, a length of the slot is about an integer multiple of a wavelength (for example, a one-fold medium wavelength). In some embodiments, the slot may be fed by a transmission line that is connected to one side or two sides of the slot. In this way, a radio frequency electromagnetic field is excited on the slot, and an electromagnetic wave is radiated to space.

In some embodiments, a material of the radiator 31 may include a dielectric, metal, ceramic, or the like.

The balun 32 is configured to perform conversion between balanced signals (two signals interacting with each other, and independent of ground) and an unbalanced signal (a single signal being grounded or pseudo-grounded). Specifically, the balun may perform conversion between a balanced (or differential) transmission line in which a current is transmitted in opposite phases and an unbalanced (or single-ended) transmission line in which a return current is transmitted underground, for example, converting a single-ended signal into a differential signal. In embodiments of this application, the balun 32 uses the transmission line structure (for example, the transmission line 400, the transmission line 500, the transmission line 600, or the transmission line 700) described in the foregoing embodiments, to implement balanced feeding.

For example, the balun 32 includes a third ground 321 and a third inner conductor 322. The third ground 321 includes a third slot hole 323 extending through a thickness of the third ground 321. The third inner conductor 322 is disposed in the third slot hole 323, and a thickness direction of a part of the third inner conductor 322 located in the third slot hole 323 intersects with a thickness direction of the third ground 321.

In embodiments of this application, for detailed descriptions of the third ground 321, the third inner conductor 322, and the third slot hole 323, refer to the foregoing descriptions of the ground 20, the inner conductor 10, and the slot hole 22. The foregoing embodiments are also applicable herein. For brevity, details are not described herein again.

In some embodiments, the thickness direction of the part of the third inner conductor 322 located in the third slot hole 323 is perpendicular to the thickness direction of the third ground 321.

In some embodiments, the third inner conductor 322 may alternatively not be completely inserted into the third slot hole 323, for example, the structure shown in FIG. 11C.

In some embodiments, as shown in FIG. 16 and FIG. 17, the antenna element 800 may further include a feed line part 33, and the feed line part 33 is electrically connected to the balun 32. In embodiments of this application, the feed line part 33 may use the transmission line structure (for example, the transmission line 400, the transmission line 500, the transmission line 600, or the transmission line 700) described in the foregoing embodiments, to feed the balun 32.

For example, the feed line part 33 includes a fourth ground 331 and a fourth inner conductor 332. The fourth ground 331 includes a fourth slot hole 333 extending through a thickness of the fourth ground 331. The fourth inner conductor 332 is disposed in the fourth slot hole 333, and a thickness direction of a part of the fourth inner conductor 332 located in the fourth slot hole 333 intersects with a thickness direction of the fourth ground 331. The fourth inner conductor 332 is electrically connected to the third inner conductor 322.

In embodiments of this application, for detailed descriptions of the fourth ground 331, the fourth inner conductor 332, and the fourth slot hole 333, refer to the foregoing descriptions of the ground 20, the inner conductor 10, and the slot hole 22. The foregoing embodiments are also applicable herein. For brevity, details are not described herein again.

In some embodiments, the thickness direction of the part of the fourth inner conductor 332 located in the fourth slot hole 333 is perpendicular to the thickness direction of the fourth ground 331.

In some embodiments, the fourth inner conductor 332 may alternatively not be completely inserted into the fourth slot hole 333, for example, the structure shown in FIG. 11C.

In some embodiments, the third inner conductor 322 is fastened to the fourth inner conductor 332. For example, the third inner conductor 322 and the fourth inner conductor 332 are integrally formed.

In some embodiments, the radiator 31 is fastened to the third ground 321; or the radiator 31 and the third ground 321 are integrally formed.

In some embodiments, the third ground 321 is fastened to the fourth ground 331; or the third ground 321 and the fourth ground 331 are integrally formed.

In some embodiments, the radiator 31, the third ground 321, and the fourth ground 331 are integrally formed.

For example, the radiator 31, the third ground 321, and the fourth ground 331 may be formed by bending a metal plate through a sheet metal process. FIG. 18 is a diagram of a structure of an antenna element before an antenna element body is formed according to an embodiment of this application. As shown in FIG. 17, a metal plate 900 is of a plate structure, and includes the radiator 31, the third ground 321, and the fourth ground 331. After being bent, the metal plate 900 may form an antenna element body (including the radiator 31, the third ground 321, and the fourth ground 331) of the antenna element 800. In this way, integrated processing can be implemented.

In some embodiments, the third inner conductor 322 and the fourth inner conductor 332 may form a +45° feed line, or the third inner conductor 322 and the fourth inner conductor 332 may form a −45° feed line.

The structures shown in FIG. 16 and FIG. 17 may be alternatively understood from the following perspectives.

As shown in FIG. 16 and FIG. 17, the antenna element 800 includes an antenna element body and a first feed line, where the antenna element body includes the radiator 31, the third ground 321, and the fourth ground 331, and the first feed line includes the third inner conductor 322 and the fourth inner conductor 332. The third slot hole 323 is provided on the third ground 321, the third inner conductor 322 is disposed in the third slot hole 323, and the thickness direction of the part of the third inner conductor 322 located in the third slot hole 323 intersects with the thickness direction of the third ground 321. The third inner conductor 322 is coupled to the third slot hole 323 for functioning as a balun to feed the radiator 31. The fourth slot hole 333 is provided on the fourth ground 331, the fourth inner conductor 332 is disposed in the fourth slot hole 333, and the thickness direction of the part of the fourth inner conductor 332 located in the fourth slot hole 333 intersects with the thickness direction of the fourth ground 331. The fourth inner conductor 332 is coupled to the fourth slot hole 333 for feeding.

In some embodiments, as shown in FIG. 17, the antenna element 800 may further include a second feed line, and the second feed line includes a fifth inner conductor 325 and a sixth inner conductor 335. A fifth slot hole 324 is provided on the third ground 321, the fifth inner conductor 325 is disposed in the fifth slot hole 324, and a thickness direction of a part of the fifth inner conductor 325 located in the fifth slot hole 324 intersects with the thickness direction of the third ground 321. The fifth inner conductor 325 is coupled to the fifth slot hole 324 for functioning as a balun to feed the radiator 31. A sixth slot hole 334 is provided on the fourth ground 331, the sixth inner conductor 335 is disposed in the sixth slot hole 334, and a thickness direction of a part of the sixth inner conductor 335 located in the sixth slot hole 334 intersects with the thickness direction of the fourth ground 331. The sixth inner conductor 335 is coupled to the sixth slot hole 334 for feeding.

Herein, the third inner conductor 322 and the fourth inner conductor 332 transmit a same electrical signal, and the fifth inner conductor 325 and the sixth inner conductor 335 transmit a same electrical signal. Electrical signals transmitted by the first feed line and the second feed line are different.

In some embodiments, one of the first feed line and the second feed line is a +45° feed line, and the other is a −45° feed line.

In some embodiments, the third inner conductor 322 of the first feed line and the fifth inner conductor 325 of the second feed line are of a cross structure.

In some embodiments, the thickness direction of the fourth inner conductor 332 of the first feed line is parallel to a thickness direction of the sixth inner conductor 335 of the second feed line.

In some embodiments, the third ground 321 includes two third slot holes 323 and two fifth slot holes 324. The two third slot holes 323 are disposed opposite to each other, and the two fifth slot holes 324 are disposed opposite to each other. The two third slot holes 323 and the two fifth slot holes 324 are alternately arranged in a clockwise direction. The third inner conductor 322 and the fifth inner conductor 325 are respectively inserted into the two third slot holes 323 and the two fifth slot holes 324 in a cross shape.

It may be understood that the two third slot holes 323 and the third inner conductor 322 form one balun, and the two fifth slot holes 324 and the fifth inner conductor 325 form another balun.

In some embodiments, the radiator 31 may include four radiation arms, and the four radiation arms are respectively connected to parts on the third ground 321 that are used to form the two third slot holes 323 and the two fifth slot holes 324.

In some embodiments, a length direction of the fourth slot hole 333 is parallel to a length direction of the sixth slot hole 334, that is, the fourth slot hole 333 and the sixth slot hole 334 are provided side by side. In this way, space occupied by the feed line part 33 can be reduced, and a plurality of feed lines can be integrated in limited space.

In embodiments, the antenna element 800 may include three parts: the first feed line, the second feed line, and the antenna element body. The antenna element 800 uses the transmission line structure provided in embodiments of this application to construct balun balanced feeding, and may further integrate a dual-polarized transmission line. Because both the balun and the feeding part use the transmission line structure provided in embodiments of this application, each feeding structure is insensitive to a size tolerance, thereby implementing a high robustness design.

When the antenna element 800 is mounted, the first feed line and the second feed line are directly inserted, and mounting is convenient. A balun part of the antenna element 800 is slitted to construct a slot line, and the first feed line and the second feed line may be inserted into the slot line for feeding. A slot is formed at the bottom of the antenna element to form a transmission line slot line, so that the antenna element 800 can further integrate a feeding transmission line, and low-cost forming can be implemented.

It should be noted that FIG. 16 and FIG. 17 schematically show an antenna element structure of a dual-polarized antenna using the transmission line provided in embodiments of this application. In some other embodiments, the transmission line structure provided in this application may be further used in an antenna element structure of a single-polarized antenna, a quad-polarized antenna, an eight-polarized antenna, or the like. Examples are not described herein.

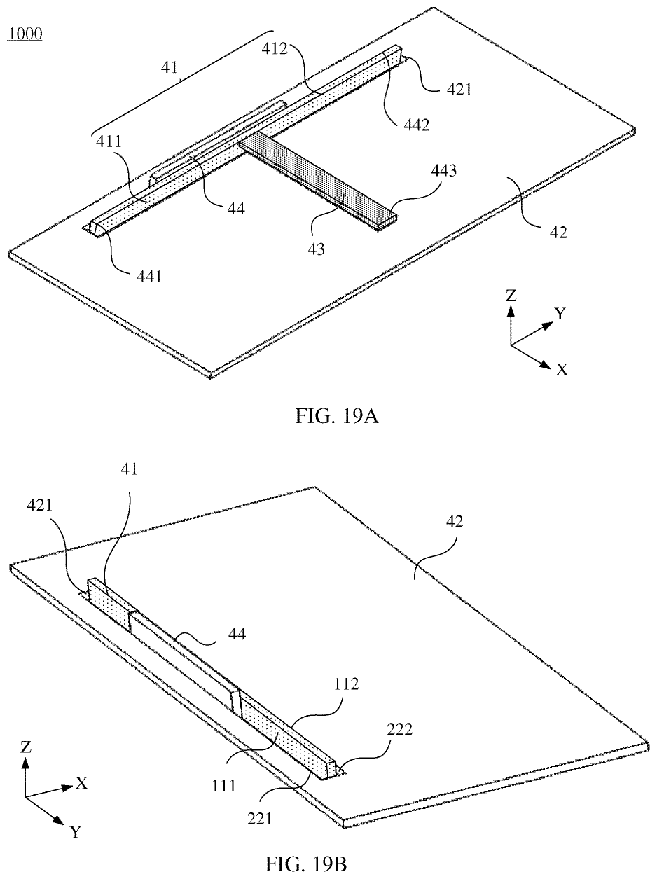

FIG. 19A and FIG. 19B are diagrams of a structure of a phase shifter according to an embodiment of this application. FIG. 19A is a schematic front view of a structure of the phase shifter 1000, and FIG. 19B is a schematic rear view of the structure of the phase shifter 1000. It may be understood that FIG. 19A and FIG. 19B are only diagrams of a structure of a basic unit of the phase shifter 1000, that is, a diagram of a structure of a phase-shifting power division section. In embodiments of this application, the phase shifter 1000 may include one or more phase-shifting power division sections shown in FIG. 19A and FIG. 19B. Herein, only one phase-shifting power division section of the phase shifter is used as an example for description.

As shown in FIG. 19A and FIG. 19B, the phase shifter 1000 may include an inner conductor 41 and a ground 42. The ground 42 includes a slot hole 421 extending through a thickness of the ground 42. The inner conductor 41 is disposed in the slot hole 421, and a thickness direction of a part of the inner conductor 41 located in the slot hole 421 intersects with a thickness direction of the ground 42. The phase shifter 1000 further includes an input stub 43. The inner conductor 41 may include a first output stub 411 and a second output stub 412. The input stub 43 is separately connected to the first output stub 411 and the second output stub 412. The input stub 43 includes an input port 443, the first output stub 411 includes a first output port 441, and the second output stub 412 includes a second output port 442. A signal transmitted through the input port 443 may be allocated to the first output port 441 and the second output port 442 based on a specific proportion. The phase shifter 1000 further includes a phase-shifting medium 44, and the phase-shifting medium 44 is configured to adjust a phase difference between the first output port 441 and the second output port 442. In other words, when the phase-shifting medium 44 moves in a length direction of the slot hole 421, the phase difference between the first output port 441 and the second output port 442 changes, thereby implementing a phase-shifting function.

In some embodiments, the input stub 43 and the inner conductor 41 may form a T-shaped phase-shifting power division section, where a joint between the input stub 43 and the inner conductor 41 is a T-shaped node.

In some embodiments, the input stub 43 may form a microstrip line with the ground 42.

In some embodiments, as shown in FIG. 19A and FIG. 19B, the phase-shifting medium 44 is disposed between one surface of the inner conductor 41 in a thickness direction and an inner wall of the slot hole 421.

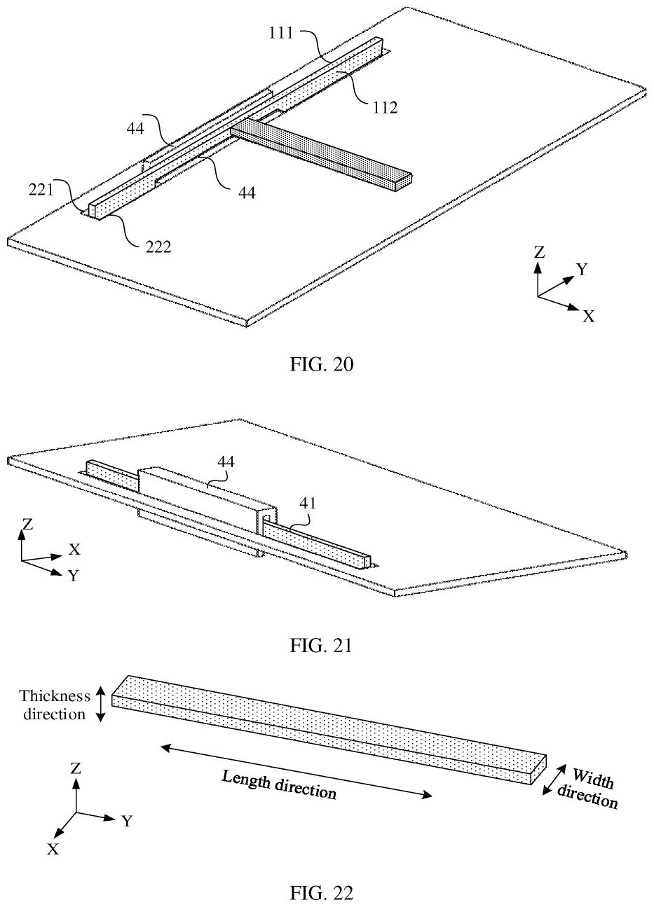

In some other embodiments, as shown in FIG. 20, the phase-shifting medium 44 is disposed between two surfaces of the inner conductor 41 in the thickness direction and the inner wall of the slot hole 421. Because the phase-shifting medium is loaded on the two surfaces of the inner conductor 41 in the thickness direction, a phase lag amount can be increased, thereby increasing an adjustment range of the phase difference, that is, increasing a phase shift amount.

For example, refer to FIG. 19B and FIG. 20. The inner conductor 41 may include a first surface 111 and a second surface 112 in the thickness direction of the inner conductor 41, and the first surface 111 and the second surface 112 are disposed opposite to each other. The inner wall of the slot hole 421 includes a first wall 221 facing the first surface 111 and a second wall 222 facing the second surface 112. The phase-shifting medium 44 is disposed between the first surface 111 and the first wall 221 and/or between the second surface 112 and the second wall 222.

In some embodiments, as shown in FIG. 21, the phase-shifting medium 44 may wrap the inner conductor 41. For example, the phase-shifting medium 44 wraps the inner conductor 41 in a direction that is around a length direction of the inner conductor 41.

In some embodiments, a material of the phase-shifting medium 44 may be polycarbonate (polycarbonate, PC). For example, the phase-shifting medium 44 may be solid, for example, a sliding medium block, and may move in the slot hole 421 relative to the inner conductor 41.

It should be noted that FIG. 19A to FIG. 20 schematically show that the transmission line provided in embodiments of this application is used in a T-shaped phase-shifting power divider (having two output ports). In some other embodiments, when the transmission line structure provided in this application is used in a phase shifter, the phase shifter may include three, four, or more output ports. For example, a plurality of phase-shifting power division sections shown in FIG. 19A and FIG. 19B are spliced to obtain a phase shifter having a plurality of output ports. Examples are not described herein.

The phase shifter 1000 uses the transmission line structure provided in embodiments of this application, so that a tolerance robustness capability of an impedance of the phase shifter can be improved, thereby helping ensure stability of the impedance of the phase shifter, and further ensuring stability of an impedance of an entire feed network.

Actually, in an antenna system, the transmission line structure provided in this application may be used at any position at which energy needs to be transmitted through a coupling capacitance. The transmission line provided in this application may also be understood as a transmission line unit. When the transmission line unit is used in different components, the transmission line unit may have different names. For example, when the transmission line unit is used in a balun, the transmission line unit may be referred to as a balun; when the transmission line unit is used in a phase shifter, the transmission line unit may be referred to as a phase shifter; and when the transmission line unit is configured to connect different components, the transmission line unit may be referred to as a transmission line (for example, the transmission line 207 shown in FIG. 2 or the transmission line 304 shown in FIG. 3).

Embodiments of this application relate to a thickness, a length, and a width of an inner conductor. The following further describes the directions with reference to FIG. 22. FIG. 22 is a diagram of a structure of an inner conductor. As shown in FIG. 22, a thickness of the inner conductor in embodiments of this application indicates a minimum size parameter of the inner conductor. For example, the thickness of the inner conductor may be a distance between two opposite main surfaces of the inner conductor. Herein, the main surface indicates a surface with a largest area on the inner conductor. Correspondingly, a direction in which the thickness of the inner conductor is located is a thickness direction of the inner conductor. A length of the inner conductor in embodiments of this application indicates a maximum size parameter of the inner conductor. For example, the length of the inner conductor may be a maximum extension size of an equal-thickness cross section. Correspondingly, a direction in which the length of the inner conductor is located is a length direction of the inner conductor. A width of the inner conductor in embodiments of this application may indicate a size parameter in a direction perpendicular to both the length direction and the thickness direction of the inner conductor. Correspondingly, the direction is a width direction of the inner conductor.

Similarly, the thickness direction of the ground in the foregoing embodiments indicates a direction in which a minimum size parameter of the ground is located.

In some embodiments, a shape of a cross section of the inner conductor that is perpendicular to the length direction may be a rectangle, a trapezoid, a parallelogram, or the like. This is not limited in this application.

It should be noted that the transmission line structure shown in FIG. 7 to FIG. 22 is merely an example. For ease of understanding, no support component is shown in the figures. For example, the inner conductor may be disposed on a support component, and cooperate with a slot hole provided on the ground by disposing the support component. Herein, the support component is made of an insulation material.

With reference to the foregoing embodiments and FIG. 7 to FIG. 22, an embodiment of this application provides a transmission line, including a first inner conductor and a ground. The first inner conductor includes a first main surface, and the first main surface is perpendicular to a thickness direction of the first inner conductor. The ground includes a first slot hole extending through a thickness of the ground, where an inner wall of the first slot hole is coupled to the first main surface to form a capacitance.

The inner wall of the first slot hole is coupled to the first main surface of the first inner conductor to form the capacitance. An area of the first main surface is much larger than an area of the inner wall of the first slot hole. When a relative position between the first inner conductor and the ground changes, a coupling capacitance between the first inner conductor and the ground changes slightly or remains substantially unchanged. In other words, sensitivity of an impedance of the transmission line to changes in the relative position between the first inner conductor and the ground is reduced, and a tolerance robustness capability of the impedance of the transmission line is improved. Therefore, stability of the impedance of the transmission line can be ensured.

For example, the first inner conductor may be the inner conductor 10 or the first inner conductor 141 in the foregoing embodiments.

For example, the ground may be the ground 20 in the foregoing embodiments.

For example, the first main surface may be the wide surface of the inner conductor 10 in the foregoing embodiments.

For example, the first slot hole may be the slot hole 22 or the first slot hole 241 in the foregoing embodiments.

In some embodiments, at least a part of a projection of the first inner conductor in a first direction overlaps with a projection of the first slot hole in the first direction, and the thickness direction of at least a part of the first inner conductor intersects with the thickness direction of the ground, where the first direction is the thickness direction of the ground.

In this way, a surface of the first inner conductor in the thickness direction of the first inner conductor may form a capacitance with the inner wall of the first slot hole. When a relative position between the first inner conductor and the ground in the vertical dimension and/or the horizontal dimension changes, a capacitance composition condition can still be met, and impact on the capacitance between the first inner conductor and the ground is small. In this way, stability of the capacitance formed between the first inner conductor and the ground can be maintained, the stability of the impedance of the transmission line can be ensured, and stability and reliability of a signal transmitted by the transmission line can be further ensured. Because the impedance of the transmission line is less sensitive to changes in a relative position between the first inner conductor and the inner wall of the first slot hole, an error range of changes in the relative position between the first inner conductor and the ground is allowed to be increased in a processing and mounting process, a high-precision processing technique or a high-cost fastening solution is not required, and fastening costs can be reduced.

In some embodiments, the thickness direction of at least the part of the first inner conductor is perpendicular to the thickness direction of the ground.

This helps to form the capacitance by coupling the first inner conductor and the ground. In addition, when sizes of the first inner conductor and the ground are fixed, this arrangement can improve a tolerance range of the impedance of the transmission line, that is, a tolerance between the first inner conductor and the ground is increased, but a coupling capacitance between the first inner conductor and the ground can still be maintained, thereby maintaining the stability of the impedance of the transmission line.

In some embodiments, the first main surface is parallel to the thickness direction of the ground.

A width of the first main surface is much greater than a thickness of the ground. Even if there is a tolerance between the first inner conductor and the ground in the vertical dimension (namely, the thickness direction of the ground), stability of the capacitance between the first inner conductor and the ground can be maintained.

In some embodiments, the first main surface includes a first surface and a second surface that are disposed opposite to each other; and the first slot hole includes a first wall facing the first surface and a second wall facing the second surface, where the first wall is parallel to the first surface, and the second wall is parallel to the second surface.

In this way, a specific distance can always be maintained between the first main surface and the inner wall of the first slot hole, to avoid contact between the first inner conductor and the ground, and improve reliability of the capacitance.

For example, the first surface may be the first surface 111 in the foregoing embodiments, and the second surface may be the second surface 112 in the foregoing embodiments.

For example, the first wall may be the first wall 221 in the foregoing embodiments, and the second wall may be the second wall 222 in the foregoing embodiments.

In some embodiments, the first inner conductor is disposed in the first slot hole.

In this way, there is a directly overlapping coupling area between the first inner conductor and the inner wall of the first slot hole, a coupling field is stronger, and a capability of binding an electric field is stronger, so that a transmission loss of the transmission line can be reduced.

In some embodiments, a projection of the first main surface in a second direction is divided into two parts arranged in the thickness direction of the ground by a projection of the ground in the second direction, and the second direction is a width direction of the ground.

In this way, when there is a tolerance in a position or a size of the first inner conductor or the ground in the vertical dimension (namely, the thickness direction of the ground), a coupling area between the first inner conductor and the ground may remain unchanged, and the stability of the capacitance between the first inner conductor and the ground can be ensured.

In some embodiments, the first slot hole includes a first slot section and a second slot section that are spaced apart in a third direction, and the third direction is a length direction of the ground; and the first inner conductor includes a first part, a second part, and a third part that connects the first part and the second part, where the first part is disposed in the first slot section, the second part is disposed in the second slot section, and the third part is located outside the first slot hole and is not in contact with a part of the ground separating the first slot section from the second slot section.

The first slot hole may include a plurality of slot sections that are spaced apart. The first inner conductor may jump out of one slot section, bypass a connecting part between adjacent slot sections, and then be inserted into another slot section. This disposing manner can enhance strength of the ground without affecting performance of the transmission line.

For example, the first slot section may be the first slot section 231 in the foregoing embodiments, and the second slot section may be the second slot section 232 in the foregoing embodiments.

For example, the first part may be the first part 131 in the foregoing embodiments, the second part may be the second part 132 in the foregoing embodiments, and the third part may be the third part 133 in the foregoing embodiments.

In some embodiments, a thickness direction of the third part is the same as a thickness direction of the first part and/or a thickness direction of the second part.

All parts of the first inner conductor have a same thickness direction. In this way, the first inner conductor may be in a plate shape, a processing technique is simple, and mounting is convenient.

In some embodiments, a thickness direction of the third part is perpendicular to a thickness direction of the first part and/or a thickness direction of the second part; and/or the thickness direction of the third part is parallel to the thickness direction of the ground.

A coupling area between the third part of the first inner conductor and the ground is increased. For example, the third part may form a microstrip line with the ground. In this way, continuity of the impedance of the transmission line can be improved.

In some embodiments, the transmission line further includes a second inner conductor, the second inner conductor includes a second main surface, and the second main surface is perpendicular to a thickness direction of the second inner conductor; and the ground further includes a second slot hole extending through the thickness of the ground, the second slot hole and the first slot hole are spaced apart in the width direction of the ground, and an inner wall of the second slot hole is coupled to the second main surface to form a capacitance.

A feeding transmission line of a radiation element can be formed by providing slot holes side by side on the ground, to facilitate integration of multi-polarized feed lines and occupy small space in a direction perpendicular to the thickness of the ground.

For example, the second inner conductor may be the second inner conductor 142 in the foregoing embodiments.

For example, the second slot hole may be the second slot hole 242 in the foregoing embodiments.

For example, the second main surface may be the wide surface of the second inner conductor 142.

In some embodiments, a length direction of the second slot hole is parallel to a length direction of the first slot hole.

The first slot hole and the second slot hole are provided side by side, to facilitate integration and mounting of a plurality of feed lines.

In some embodiments, coupling between the first slot hole and the first inner conductor is configured to transmit a first signal, and coupling between the second slot hole and the second inner conductor is configured to transmit a second signal.

In this way, the transmission line may occupy smaller space to transmit a plurality of feed line signals.

An embodiment of this application further provides an antenna element, including a radiator and a balun. The radiator is configured to receive and transmit a radio frequency signal. The balun is electrically connected to the radiator. The balun includes the transmission line in the foregoing embodiments, to feed the radiator.

The balun of the antenna element uses the foregoing transmission line structure, so that a tolerance robustness capability of an impedance of the balun can be improved, and stability of the impedance of the balun can be ensured.

For example, the radiator may be the radiator 31 in the foregoing embodiments.

For example, the balun may be the balun 32 in the foregoing embodiments.

In some embodiments, the antenna element further includes a feed line part, electrically connected to the balun, where the feed line part includes the transmission line in the foregoing embodiments, to feed the balun.

Both the balun and the feed line part of the antenna element use the foregoing transmission line structure. Therefore, the balun and the feed line part are insensitive to changes in positions of the inner conductor and the ground, and a high robustness design can be implemented.

For example, the feed line part may be the feed line part 33 in the foregoing embodiments.

In some embodiments, a ground in the balun is connected to a ground in the feed line part; and/or a first inner conductor in the balun is connected to a first inner conductor in the feed line part.

In some embodiments, the radiator, the ground in the balun, and the ground in the feed line part are integrally formed.

The radiator, the ground in the balun, and the ground in the feed line part are appropriately arranged, to achieve integrated formation through a single processing technique, for example, by using single-sided sheet metal bending. This process is simple, and costs are low.

In some embodiments, the first inner conductor in the balun and the first inner conductor in the feed line part are integrally formed.

In this way, balun feeding and the feed line feeding can be achieved by mounting only one part, so that mounting is simple, and costs are low.

In some embodiments, the first inner conductor in the balun and the first inner conductor in the feed line part are part of a +45° feed line or part of a −45° feed line. In this way, the balun and the feed line part may be used for ±45° dual-polarized feeding.

An embodiment of this application further provides a phase shifter, where the phase shifter includes the transmission line in the foregoing embodiments.

In some embodiments, the phase shifter further includes: an input stub, where the input stub is connected to the first inner conductor, and the first inner conductor includes at least two output ports; and a phase-shifting medium disposed between the inner wall of the first slot hole and the first main surface, where the phase-shifting medium is configured to adjust a phase difference between the at least two output ports.

The phase shifter uses the foregoing transmission line structure, so that a tolerance robustness capability of an impedance of the phase shifter can be improved, and stability of the impedance of the phase shifter can be ensured.

For example, the input stub may be the input stub 43 in the foregoing embodiments.

For example, the first inner conductor may include the first output port 441 and the second output port 442 shown in FIG. 19A.

For example, the phase-shifting medium may be the phase-shifting medium 44 in the foregoing embodiments.

In some embodiments, the first main surface includes a first surface and a second surface that are disposed opposite to each other; the first slot hole includes a first wall facing the first surface and a second wall facing the second surface; and the phase-shifting medium is disposed between the first surface and the first wall and/or between the second surface and the second wall.

When the phase-shifting medium moves in the length direction of the first slot hole, the phase difference between the at least two output ports provided on the first inner conductor changes, so that a phase-shifting function can be implemented. In addition, when the phase-shifting medium is loaded on both two wide surfaces of the first inner conductor, a phase lag amount may be increased, thereby increasing a phase shift amount.

For example, the first surface may be the first surface 111 in the foregoing embodiments, and the second surface may be the second surface 112 in the foregoing embodiments.

For example, the first wall may be the first wall 221 in the foregoing embodiments, and the second wall may be the second wall 222 in the foregoing embodiments.

An embodiment of this application further provides a feed network. The feed network includes the transmission line in the foregoing embodiments, or includes the phase shifter in the foregoing embodiments.

An embodiment of this application further provides an antenna. The antenna includes the transmission line in the foregoing embodiments, or includes a phase shifter in which the transmission line in embodiments of this application is used, or includes a feed network in which the transmission line in embodiments of this application is used.

An embodiment of this application further provides a communication device, including a radio frequency module and the antenna that is described in the foregoing embodiments and in which the transmission line in embodiments of this application is used. The radio frequency module is configured to send a radio frequency signal to the antenna.

In some embodiments, the radio frequency module integrates two or more discrete components such as a radio frequency switch, a low noise amplifier, a filter, a duplexer, and a power amplifier into one module. In this way, integration and performance can be improved, and miniaturization can be achieved.

In some embodiments, the antenna may receive a radio frequency signal from the radio frequency module, and transmit the radio frequency signal. In addition, the antenna may further send a received radio frequency signal to the radio frequency module. It should be noted that a frequency of the radio frequency signal is not limited in embodiments of this application.

In some embodiments, the communication device may further include an energy apparatus, and the energy apparatus is configured to provide energy for the radio frequency module and the antenna.

In some embodiments, the communication device may be integrated into the base station 101 shown in FIG. 1.

An embodiment of this application further provides a communication system. The communication system may include a terminal device and a base station. The base station may include the antenna described in the foregoing embodiments.

It may be understood that the ground and the inner conductor in embodiments of this application are not in contact with each other.

In the descriptions of this application, it should be noted that terms “mount”, “connected”, and “connection” should be understood in a broad sense unless there is a clear stipulation and limitation. For example, “connection” may be a fixed connection, a detachable connection, or an integrated connection; may be a mechanical connection or an electrical connection; and may be a direct connection, an indirect connection through an intermediate medium, or a connection inside two elements. A person of ordinary skill in the art may understand specific meanings of the foregoing terms in this application based on a specific situation.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A transmission line, comprising:
a first inner conductor, comprising a first main surface, wherein the first main surface is perpendicular to a thickness direction of the first inner conductor; and
a ground, comprising a first slot hole extending through a thickness of the ground, wherein an inner wall of the first slot hole is coupled to the first main surface to form a capacitance.

2. The transmission line according to claim 1, wherein at least a part of a projection of the first inner conductor in a first direction overlaps with a projection of the first slot hole in the first direction, and the thickness direction of at least a part of the first inner conductor intersects with a thickness direction of the ground, wherein the first direction is the thickness direction of the ground.

3. The transmission line according to claim 2, wherein the thickness direction of at least the part of the first inner conductor is perpendicular to the thickness direction of the ground.

4. The transmission line according to claim 1, wherein the first main surface is parallel to the thickness direction of the ground.

5. The transmission line according to claim 1, wherein
the first main surface comprises a first surface and a second surface that are disposed opposite to each other; and
the first slot hole comprises a first wall facing the first surface and a second wall facing the second surface, wherein the first wall is parallel to the first surface, and the second wall is parallel to the second surface.

6. The transmission line according to claim 1, wherein the first inner conductor is disposed in the first slot hole.

7. The transmission line according to claim 6, wherein a projection of the first main surface in a second direction is divided into two parts arranged in the thickness direction of the ground by a projection of the ground in the second direction, and the second direction is a width direction of the ground.

8. The transmission line according to claim 1, wherein
the first slot hole comprises a first slot section and a second slot section that are spaced apart in a third direction, and the third direction is a length direction of the ground; and
the first inner conductor comprises a first part, a second part, and a third part that connects the first part and the second part, wherein the first part is disposed in the first slot section, the second part is disposed in the second slot section, and the third part is located outside the first slot hole and is not in contact with a part of the ground separating the first slot section from the second slot section.

9. The transmission line according to claim 8, wherein a thickness direction of the third part is the same as a thickness direction of the first part and/or a thickness direction of the second part.

10. The transmission line according to claim 8, wherein
a thickness direction of the third part is perpendicular to a thickness direction of the first part and/or a thickness direction of the second part; and/or
the thickness direction of the third part is parallel to the thickness direction of the ground.

11. The transmission line according to claim 1, wherein the transmission line further comprises a second inner conductor, the second inner conductor comprises a second main surface, and the second main surface is perpendicular to a thickness direction of the second inner conductor; and
the ground further comprises a second slot hole extending through the thickness of the ground, the second slot hole and the first slot hole are spaced apart in the width direction of the ground, and an inner wall of the second slot hole is coupled to the second main surface to form a capacitance.

12. The transmission line according to claim 11, wherein a length direction of the second slot hole is parallel to a length direction of the first slot hole.

13. The transmission line according to claim 11, wherein coupling between the first slot hole and the first inner conductor is configured to transmit a first signal, and coupling between the second slot hole and the second inner conductor is configured to transmit a second signal.

14. An antenna element, comprising:
a radiator, configured to transmit and receive a radio frequency signal; and
a balun, electrically connected to the radiator, wherein the balun comprises the transmission line, to feed the radiator, wherein the transmission line comprises:
a first inner conductor, comprising a first main surface, wherein the first main surface is perpendicular to a thickness direction of the first inner conductor; and
a ground, comprising a first slot hole extending through a thickness of the ground, wherein an inner wall of the first slot hole is coupled to the first main surface to form a capacitance.

15. The antenna element according to claim 14, wherein the antenna element further comprises:
a feed line part, electrically connected to the balun, wherein the feed line part comprises the transmission line, to feed the balun, wherein the transmission line comprises:
a first inner conductor, comprising a first main surface, wherein the first main surface is perpendicular to a thickness direction of the first inner conductor; and
a ground, comprising a first slot hole extending through a thickness of the ground, wherein an inner wall of the first slot hole is coupled to the first main surface to form a capacitance.

16. The antenna element according to claim 15, wherein
a ground in the balun is connected to a ground in the feed line part; and/or
a first inner conductor in the balun is connected to a first inner conductor in the feed line part.

17. The antenna element according to claim 15, wherein
the radiator, the ground in the balun, and the ground in the feed line part are integrally formed; and/or
the first inner conductor in the balun and the first inner conductor in the feed line part are integrally formed.

18. The antenna element according to claim 15, wherein the first inner conductor in the balun and the first inner conductor in the feed line part are part of a +45° feed line or part of a −45° feed line.

19. A phase shifter, comprising the transmission line, wherein the transmission line comprises:
a first inner conductor, comprising a first main surface, wherein the first main surface is perpendicular to a thickness direction of the first inner conductor; and
a ground, comprising a first slot hole extending through a thickness of the ground, wherein an inner wall of the first slot hole is coupled to the first main surface to form a capacitance.

20. The phase shifter according to claim 19, wherein the phase shifter further comprises:
an input stub, wherein the input stub is connected to the first inner conductor, and the first inner conductor comprises at least two output ports; and
a phase-shifting medium, disposed between the inner wall of the first slot hole and the first main surface, wherein the phase-shifting medium is configured to adjust a phase difference between the at least two output ports.
